(19) United States
(12) Patent Application Publication
(10) Pub. No.: US 2013/0063393 A1
(43) Pub. Date: Mar. 14, 2013

(54) FUNCTIONAL LAMINATED PLATE, AND TRANSPARENT ELECTRICALLY CONDUCTIVE LAMINATED PLATE FOR TOUCH PANEL AND TOUCH PANEL PRODUCED USING SAME

(71) Applicants: Susumu Kurishima, Saitama (JP); Satoshi Negishi, Saitama (JP); Takeshi Hasegawa, Saitama (JP); Takayuki Aikawa, Saitama (JP); Koji Takahashi, Tokyo (JP); Seiji Ushio, Tokyo (JP)

(72) Inventors: Susumu Kurishima, Saitama (JP); Satoshi Negishi, Saitama (JP); Takeshi Hasegawa, Saitama (JP); Takayuki Aikawa, Saitama (JP); Koji Takahashi, Tokyo (JP); Seiji Ushio, Tokyo (JP)

(21) Appl. No.: 13/579,492

(22) PCT Filed: Feb. 24, 2011
(86) PCT No.: PCT/JP2011/054151

§ 371 Date: Aug. 16, 2012

(30) Foreign Application Priority Data
Mar. 4, 2010 (JP) 2010-047257
Mar. 4, 2010 (JP) 2010-047258
Mar. 4, 2010 (JP) 2010-047259

(51) Int. Cl. B32B 27/00; G06F 3/044; G06F 3/045; B32B 7/02

(52) U.S. Cl. CPC B32B 27/00; B32B 7/02; G06F 3/044; G06F 3/045
USPC 345/174; 428/411.1; 428/213

(57) ABSTRACT

Disclosed is a functional laminated sheet having flexibility, high body and good die cutting workability. The functional laminated sheet comprises a laminated sheet composed of at least two plastic films bound to each other through an adhesive layer and a functional layer formed on one surface or both surfaces of at least one of the plastic films, wherein the adhesive layer has a Martens hardness of 260 N/mm² or less. The functional layer is, for example, a layer having an electromagnetic wave shielding function, a heat ray reflection function, a gas barrier function or a planar heat generation function, and can be arranged in the inside of the laminated sheet. Alternatively, the functional layer is a layer having a light reflection function, a light permeation control function or an antifogging function, and can be arranged on the outermost surface of the laminated sheet. Also disclosed is a transparent electrically conductive laminated sheet for a touch panel, which comprises a transparent laminated sheet having a transparent plastic film bonded thereto through the adhesive layer and a transparent electrically conductive layer formed on the transparent laminated sheet.

This application is a U.S. national phase filing under 35 U.S.C. §371 of PCT Application No. PCT/JP2011/054151, filed Feb. 24, 2011, and claims priority under 35 U.S.C. §119 to Japanese patent application nos. 2010-047259; 2010-047258 and 2010-047257, all filed Mar. 4, 2010, the entireties of all of which are incorporated herein by reference.

### TECHNICAL FIELD

The present invention relates to a functional laminated plate and to the one having stronger stiffness while having smaller thickness, in which a plastic film can be prevented from separating off from an adhesive layer during die cutting processing. Moreover, the present invention relates to a transparent electrically conductive laminated plate for a touch panel with excellent workability (die cutting processing), which is lightweight and has no risk of damage, and to a touch panel including the same.

### BACKGROUND ART

In recent years, a variety of functional films have appeared such as an electromagnetic wave shielding film, a heat ray reflection film, a gas barrier film, a light reflection film, a light transmission control film, and an antifogging film. Since these functional films lack in stiffness when used alone, they are used by being adhered to a reinforcing sheet such as a plastic sheet.

Although a functional laminated plate including a functional film adhered to a plastic sheet has favorable stiffness, the flexibility is low because the thickness is large. Furthermore, another problem occurs in that the sheet cracks in die cutting processing for obtaining a desired size. A functional plastic sheet including a functional layer directly formed on a plastic sheet has a similar problem.

Bonding a functional film on, or forming a functional layer on a plastic sheet which already has a predetermined size is an idea for avoiding the problem with the die cutting processing; however, this idea leads to a problem of lower workability.

Meanwhile, an electrostatic capacitive touch panel or a resistive touch panel includes an electrode in which a transparent electrically conductive film is provided for a transparent base. A plastic film is sometimes used as the transparent base; however, when the durability or stiffness matters, glass is used.

However, the use of glass as the transparent base leads to problems of larger weight and higher risk of scattering when the glass is damaged. For solving the problems, the use of a plastic sheet with sufficient thickness as the transparent base is considered.

A transparent electrically conductive laminated plate including a plastic sheet with sufficient thickness as the transparent base has sufficient stiffness; however, problems occur in that the stiffness is too high to secure tactile sensation (touch sensitivity) and that the sheet cracks in die cutting processing for obtaining a desired size.

Even in this case, forming a transparent electrically conductive layer on a transparent plastic sheet which already has a predetermined size is considered for avoiding the problems in the die cutting processing; however, this leads to a problem of lower workability.

The present applicant has proposed a technique for providing a laminated plate in which two or more plastic films are adhered to each other through an adhesive layer as a material suitable for a surface protection film or the like (Patent Document 1). This laminated plate has a characteristic of strong stiffness while having reduced thickness, and for solving the problems above, the laminated plate is considered to be used as a base for forming a functional film or a transparent electrically conductive layer.

### REFERENCES

### Patent Document

Patent Document 1: WO2007/080774 (Claims)

### DISCLOSURE OF THE INVENTION

### Problems to be Solved by the Invention

In the laminated plate according to Patent Document 1, crack during the die cutting processing can be prevented, but sometimes separation (delamination) or floating has occurred between the plastic film and the adhesive layer.

In view of this, an aspect of the present invention is to provide a thin and flexible functional laminated plate with strong stiffness that does not cause separation or floating between a plastic film and an adhesive layer during die cutting processing. Another aspect of the present invention is to provide a transparent electrically conductive laminated plate for a touch panel that has no risk of damage during handling and that has sufficient stiffness and tactile sensation (touch sensitivity) in spite of lightweight.

### Solutions to the Problems

The present inventors have completed the present invention by discovering that just improving the adhesion between the plastic film and the adhesive layer cannot solve the separation or floating between the plastic film and the adhesive layer in the die cutting processing performed on the laminated plate, and that the hardness of the adhesive layer affects the floating and the separation.

In other words, the present invention relates to a functional laminated plate including at least two plastic films adhered to each other through an adhesive layer, at least one of the plastic films being a functional layer, characterized in that the Martens hardness of the adhesive layer is 260 N/mm² or less. In the present invention, the functional layer refers to a layer that provides a plastic film used with a physical function that the plastic film does not have, such as an optical function, an electrical function, a thermodynamic function, or a shielding function against heat ray, gas, or the like.

A first aspect of a functional laminated plate of the present invention is a laminated plate including at least two plastic films adhered to each other through an adhesive layer, characterized in that at least one functional layer is provided between the plastic film and the plastic film and the adhesive layer has a Martens hardness of 260 N/mm² or less.

A second aspect of a functional laminated plate of the present invention is a laminated plate including at least two plastic films adhered to each other through an adhesive layer, characterized in that a functional layer is provided to at least one surface of the plastic film on the outermost surface and the adhesive layer has a Martens hardness of 260 N/mm² or less.

A third aspect of a functional laminated plate of the present invention is a transparent electrically conductive laminated plate for a touch panel, and specifically characterized in that a transparent electrically conductive layer is provided to at least one surface of a transparent laminated plate including at least two transparent plastic films adhered to each other through an adhesive layer with a Martens hardness of 260 N/mm² or less.

In the functional laminated plate according to the first aspect, the functional layer has a function selected from, for example, an electromagnetic wave shielding function, a heat ray reflection function, a gas barrier function, and a planar heat generation function.

In the functional laminated plate according to the second aspect, the functional layer has a function selected from, for example, a light reflection function, a light transmission control function, and an antifogging function.

The functional laminated plate according to the present invention is characterized in that, preferably, the plastic films and the adhesive layer have a total thickness of 250 to 700 μm and each of plastic films has a thickness of 50 to 400 μm.

Further, in the functional laminated plate according to the present invention, resin included in the adhesive layer preferably contains a thermosetting resin or an ionizing radiation curable resin.

In addition, a touch panel according to the present invention is characterized by including the aforementioned transparent electrically conductive laminated plate for a touch panel.

That is to say, a first aspect of the touch panel of the present invention is an electrostatic capacitive touch panel including a transparent electrically conductive base including a transparent electrically conductive layer on at least one surface of a transparent base, characterized in that the transparent base is a transparent laminated plate including at least two transparent plastic films adhered to each other through an adhesive layer having a Martens hardness of 260 N/mm² or less.

A second aspect of the touch panel according to the present invention is a resistive touch panel including an upper electrode including a transparent electrically conductive layer on a transparent base and a lower electrode including a transparent electrically conductive layer on a transparent base, wherein the upper electrode and the lower electrode are adhered to each other through spacers so that the transparent electrically conductive layers face each other, characterized in that the transparent base of the upper electrode and/or the transparent base of the lower electrode is a transparent laminated plate including at least two plastic films adhered to each other through an adhesive layer having a Martens hardness of 260 N/mm² or less.

### Effects of the Invention

A functional laminated plate according to the present invention has a structure in which at least two plastic films are adhered to each other through an adhesive layer. This can provide a laminated plate in which separation or floating between the plastic film and the adhesive layer does not occur and which has small thickness, strong stiffness, and good die cutting workability. Moreover, the functional laminated plate according to the present invention has stronger stiffness than one plastic film with the same thickness, so that crack can be prevented during the die cutting processing. It is considered that the functional laminated plate is less likely to crack because the plastic film of the laminated plate can be the one with the thickness of such a degree that the die cutting processing is easily performed and because the shock during the die cutting processing is absorbed in the adhesive layer.

The transparent electrically conductive laminated plate for a touch panel according to the present invention is lightweight and has no risk of damage during handling. Thus, a touch panel with stiffness and tactile sensation (touch sensitivity) in spite of lightweight and with no risk of glass scattering during handling can be provided.

### BRIEF DESCRIPTION OF THE DRAWINGS

FIG. 1 is a cross-sectional view showing an embodiment of a functional laminated plate according to a first aspect of the present invention.

FIG. 2 is a cross-sectional view showing another embodiment of the functional laminated plate according to the first aspect of the present invention.

FIG. 3 is a cross-sectional view showing another embodiment of the functional laminated plate according to the first aspect of the present invention.

FIG. 4 is a cross-sectional view showing another embodiment of the functional laminated plate according to the first aspect of the present invention.

FIG. 5 is a cross-sectional view showing an embodiment of a functional laminated plate according to a second aspect of the present invention.

FIG. 6 is a cross-sectional view showing another embodiment of the functional laminated plate according to the second aspect of the present invention.

FIG. 7 is a cross-sectional view showing another embodiment of the functional laminated plate according to the second aspect of the present invention.

FIG. 8 is a cross-sectional view showing an embodiment of a transparent electrically conductive laminated plate for a touch panel according to the present invention.

FIG. 9 is a cross-sectional view showing another embodiment of the transparent electrically conductive laminated plate for a touch panel according to the present invention.

FIG. 10 is a cross-sectional view showing another embodiment of the transparent electrically conductive laminated plate for a touch panel according to the present invention.

FIG. 11 is a cross-sectional view showing an embodiment of an electrostatic capacitive touch panel (surface type) according to the present invention.

FIG. 12 is a cross-sectional view showing an embodiment of an electrostatic capacitive touch panel (projection type) according to the present invention.

FIG. 13 is a cross-sectional view showing an embodiment of a resistive touch panel according to the present invention.

### DESCRIPTION OF PREFERRED EMBODIMENTS

Embodiments of the present invention are described below.

A functional laminated plate and a transparent electrically conductive laminated plate for a touch panel according to the present invention (the both may be collectively referred to as a functional laminated plate unless particularly discriminated) commonly have a laminated plate structure in which at least two plastic films are adhered to each other through an adhesive layer. Materials and structures of the laminated plate which are common to the embodiments are described first.

As the plastic film, any of polyester-based films including polyethylene terephthalate, polybutylene terephthalate, and polyethylene naphthalate, and a variety of plastic films including polyethylene, polypropylene, triacetylcellulose, polyvinyl chloride, acrylic resin, and the like can be used. Among those, a polyethylene terephthalate film which has been stretched, especially biaxially stretched, is preferable because the stiffness is high and crack is less likely to occur in die cutting processing. In the case of using three or more plastic films, preferably, each surface is provided with a biaxially stretched polyethylene terephthalate film and another plastic film is sandwiched. Note that the surface of the plastic film may be subjected to adhesion-increasing processing such as corona discharge processing or undercoating adhesion-increasing processing.

When the functional laminated plate is used as the transparent electrically conductive laminated plate for a touch panel or when the laminated plate includes a functional layer and needs light transparency, the plastic film with high transparency is used. When the transparency is not necessary depending on the properties of the functional layer, the plastic film with no light transparency may be used; for example, a foamed film or a white or black film can be used.

Each of the plastic films preferably has a thickness of 50 to 400 μm, more preferably 100 to 350 μm, and further more preferably 150 to 300 μm. When each of the plastic films has thickness in such a range, die cutting processing is easily performed and crack can be prevented more easily in die cutting processing. The transparent electrically conductive laminated plate for a touch panel can have favorable tactile sensation. For preventing the bending, when the functional laminated plate includes two plastic films, the two plastic films preferably have the same thickness; when the functional laminated plate includes three or more plastic films, the two plastic films on the surface side preferably have the same thickness. For example, both surfaces of a 400-μm-thick plastic film are provided with thin plastic films with the same thickness.

The total thickness of the plastic film and the adhesive layer of the functional laminated plate (the thickness obtained by subtracting the thickness of the functional layer from the thickness of the functional laminated plate) is preferably 200 μm to 1 mm, and the lower limit is more preferably 250 μm or more and further more preferably 300 μm or more. In the case of the functional laminated plate according to the first and third aspects, the lower limit is particularly preferably 350 μm or more. By setting the thickness at 250 μm or more, the stiffness that does not easily allow bending can be provided. The upper limit is preferably 700 μm or less. By setting the thickness at 1 mm or less, the die cutting processing can be easily performed. The transparent electrically conductive laminated plate for a touch panel can have appropriate stiffness and favorable tactile sensation.

The adhesive layer includes resin and an additive, which is added as necessary. As the resin included in the adhesive layer, a thermosetting resin or an ionizing radiation curable resin, which is cross-linked and cured by heating and/or ionizing radiation irradiation or the like, is suitably used. These resins, after bridging and curing, can increase the adhesion with the plastic film and increase the stiffness of the functional laminated plate.

The thermosetting resin is preferably a thermosetting resin which can be cross-linked and cured with heat less than or equal to the upper limit of the heat resistance temperature of the plastic film in view of a request in production that an application liquid containing the thermosetting resin is applied on the plastic film and cross-linked and cured with heat. Specifically, the one that can thermally cross-link and cure resin with a cross-linking property such as a melamine-, epoxy-, amino-alkyd-, urethane-, acrylic-, polyester-, phenol-based resin can be used. In particular, an acrylic-based thermosetting resin that can increase the stiffness in a functional laminated plate and that has excellent adhesion with the plastic film is preferable. These can be used alone but is desirably used in combination with a curing agent for improving the hardness of an applied film formed by cross-linking and curing. In the present invention, the thermosetting resin also refers to a room-temperature curable resin that cures at room temperature (5 to 35° C.).

As the curing agent, a compound such as polyisocyanate, an amino resin, an epoxy resin, or carboxylic acid can be used as appropriate in accordance with the resin to be employed.

As the ionizing radiation curable resin, the one including at least a paint that can be cross-linked and cured by the irradiation with an ionizing radiant beam (UV ray or electronic beam) is preferably used. As such an ionizing radiation curable paint, one or a mixture of two or more of a photocation polymerizable resin capable of photocation polymerization, a photopolymerizable prepolymer capable of photoradical polymerization, and photopolymerizable monomer can be used. Various additives can be added to such an ionizing radiation curable paint; in the case of using a UV ray for curing, a photopolymerization initiator, UV-sensitizer, or the like is preferably added.

The adhesive layer may contain, in addition to the aforementioned curable resin, a thermoplastic resin such as an acrylic-based sticky resin. By admixing the thermoplastic resin, the adhesive layer can have a pressure-sensitive adhesion property at room temperature, so that the plastic films can be adhered to each other easily. Moreover, by admixing the thermoplastic resin, the Martens hardness can be adjusted to be low. Thus, separation or floating is less likely to occur between the plastic film and the adhesive layer during the die cutting processing. For acquiring a functional laminated plate with strong stiffness, the thermoplastic resin preferably occupies 60% or less of the resin included in the adhesive layer.

The adhesive layer may contain, in addition to the aforementioned resin, an additive such as a leveling agent, a UV absorbent, an anti-oxidation agent, an antistatic agent, a pigment, or a dye in the range where the functions of later-described functional layers are not interrupted. Moreover, the adhesive layer may have another function by addition of an additive, for example. For example, the adhesive layer can have a function of an optical diffusion sheet or a function of a transmission type screen by adding an optical diffusion agent in the adhesive layer.

The adhesive layer is cured by heating and/or irradiation with an ionizing radiant beam on the aforementioned thermosetting resin or ionizing radiation curable paint. The curing described here refers to the change of the paint from the state with fluidity at room temperature to the state having no fluidity. The degree of curing may have a range. The degree of curing can be adjusted by the amount of the irradiation.

The thickness of the adhesive layer after the curing is preferably 1 to 50 μm. The lower limit thereof is preferably 2 μm or more, more preferably 5 μm or more, and particularly preferably 10 μm or more. The upper limit thereof is preferably 40 μm or less, and more preferably 30 μm or less. With the thickness of greater than or equal to 1 μm, sufficient stiffness and adhesion strength can be obtained. The thickness is set to 50 μm or less because the thickness of greater than or equal to 50 μm cannot provide enough effect of strong stiffness compensating the larger thickness, and leads to too large thickness of a functional laminated plate. Further, when the thickness of the adhesive layer is increased, the amount of the irradiation of the plastic film with the ionizing radiation is increased, which results in the deterioration of the plastic film.

As for the hardness of the adhesive layer after the curing, the Martens hardness is 260 N/mm² or less, preferably 200 N/mm² or less, and particularly preferably 100 N/mm² or less. The Martens hardness represents the hardness (difficulty of being dent) of the adhesive layer, which is calculated from a test load and dented area observed when the surface of the adhesive layer is pushed with a Vickers indenting tool, and serves as an index of the hardness of the adhesive layer. In this specification, the Martens hardness is the value measured by a method based on ISO-14577-1 under an atmosphere in which the temperature is 20° C. and the relative humidity is 60%.

When the adhesive layer has a Martens hardness of 260 N/mm² or less, the separation or floating between the plastic film and the adhesive layer and between the functional layer and the adhesive layer can be prevented in the die cutting processing. It is considered that this is because the Martens hardness of greater than 260 N/mm² requires a large force for cutting the plastic film with a blade and the repelling force of the plastic film becomes too large, resulting in that the separation or floating occurs between the plastic film and the functional layer, and the adhesive layer. The lower limit of the Martens hardness is preferably 1 N/mm² or more, and more preferably 2 N/mm² or more. By setting the Martens hardness at 1 N/mm² or more, the strong stiffness can be maintained and even when the laminated plate is locally pressed, a pressure mark can be prevented from remaining.

As for the method of setting the Martens hardness of the adhesive layer at 260 N/mm² or less, a means is given in which the composition of monomer or oligomer included in the resin of the adhesive layer or the composition of the resins and additives in the adhesive layer (the combination of resins with different Martens hardness or addition of a thermoplastic resin, for example) is adjusted. In particular, an acrylate-based monomer with a hydroxy group or an amino group is preferably used as the photopolymerizable monomer. The use of the acrylate-based monomer with a hydroxy group or an amino group can increase the adhesion strength, and by adjusting the amount thereof, the Martens hardness can be adjusted. Specifically, an acrylate with a hydroxy group, such as hydroxyethyl acrylate, hydroxypropyl acrylate, 2-hydroxybutyl acrylate, and 4-hydroxybutyl acrylate, a methacrylate with a hydroxy group, such as hydroxyethyl methacrylate, hydroxypropyl methacrylate, and 2-hydroxybutyl methacrylate, an acrylamide such as dimethylacrylamide, dimethylaminopropylacrylamide, diethylacrylamide, and hydroxyethylacrylamide, dimethylaminoethyl acrylate, acryloylmorpholine, and the like is given.

In addition, the Martens hardness can be adjusted by, as aforementioned, adding a thermoplastic resin or increasing and decreasing the amount of the irradiation with the ionizing radiant beam for curing the adhesive layer.

As for the adhesion strength of the adhesive layer, the adhesion strength is preferably the appropriate one that does not easily allow the separation between the functional layer and the adhesive layer or between the plastic film and the adhesive layer after the curing of the adhesive layer. The one that easily allows the separation would cause the separation or floating due to the repelling force of the plastic film in the die cutting processing and the one that does not easily allow the separation but has low adhesion strength would cause the separation or floating due to the repelling force of the plastic film at the die cutting processing. Specifically, the adhesion strength between the plastic film or the functional layer and the adhesive layer is preferably 5 Newtons per 25 mm in width or more, more preferably 10 Newtons per 25 mm in width or more, and further more preferably 15 Newtons per 25 mm in width or more at which the separation is difficult.

The adhesion strength can be adjusted by adjusting the kind of monomer or oligomer included in the resins of the adhesive layer or by adjusting the composition of the resins.

The pencil hardness (JIS-K5600-5-4: 1999) of the adhesive layer is preferably HB or more from the viewpoint of the stiffness.

Next, a specific structure of the functional layer is described. A structure in which the functional layer is provided between the plastic films of the aforementioned laminated plate (Embodiment 1), a structure in which the functional layer is provided as the outermost surface layer of the laminated plate (Embodiment 2), and a structure of a transparent electrically conductive laminated plate for a touch panel (Embodiment 3) are sequentially described.

### Embodiment 1

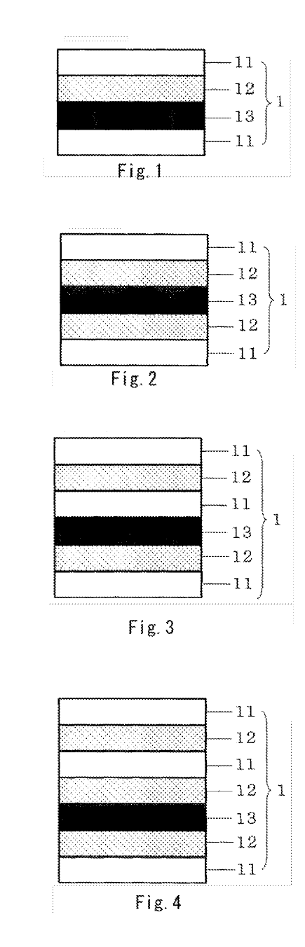

A functional laminated plate according to Embodiment 1 includes at least one functional layer between a plastic film and a plastic film. Specific examples thereof are described with reference to FIG. 1 to FIG. 4. In FIG. 1 and FIG. 2, the number of plastic films is two; in FIG. 3 and FIG. 4, the number of plastic films is three. Although depending on the purpose or film-formation method of the functional layer, the position of a functional layer 13 in a laminated plate 1 may be between a plastic film 11 and an adhesive layer 12 as depicted in FIG. 1 or FIG. 3, or may be between the adhesive layers 12 as depicted in FIG. 2 or FIG. 4. Since the functional laminated plate according to this embodiment includes the functional layer inside the laminated plate, the functional layer can be prevented from being damaged and the durability thereof can be improved.

As the functional layer of this embodiment, a layer having a function selected from an electromagnetic wave shielding function, a heat ray reflection function, a gas barrier function, and a planar heat generation function is given.

The layer having the electromagnetic wave shielding function can be formed by providing an electrically conductive material in a lattice form or providing an electrically conductive layer all over a surface.

The electrically conductive lattice pattern has preferably a pitch of approximately 40 to 250 meshes [the number of lattices per inch (25.4 mm)], and a line width of the lattice of 100 μm or less, and more preferably a pitch of 50 to 200 meshes and a line width of the lattice of 70 μm or less. When the pitch of the lattice is more than 250 meshes, the transmittance of a visible light ray tends to decrease; on the other hand, when the pitch of the lattice is less than 40 meshes, the lattice pattern tends to be visually prominent. When the line width of the lattice is more than 100 μm, the lattice tends to be visually prominent.

The electrically conductive lattice pattern can be provided by bonding an electrically conductive mesh to a plastic film, by applying, drying, and curing an electrically conductive paste in a lattice pattern on a plastic film, or by forming metal in a lattice pattern through plating or etching, for example.

The electrically conductive layer can be provided by applying, drying, and curing an electrically conductive paste on entire surface of a plastic film, by bonding a metal foil to a plastic film, or by forming metal or a metal oxide on a plastic film through sputtering or deposition, for example. The electrically conductive layer is preferably formed by alternately stacking a metal layer and a dielectric layer, or by alternately stacking a material layer with a high refractive index and a material layer with a low refractive index. Such an electrically conductive layer can improve the transparency.

As a means for forming the layer having the electromagnetic wave shielding function, a means is given in which a metal microparticle solution capable of self-organizing is applied and dried in a plastic film form. According to this means, an irregular mesh pattern can be formed, so that the occurrence of moire can be prevented. As the metal microparticle solution capable of self-organizing, a material described in JP-T-2008-546165 can be used.

The layer having the heat ray reflection function includes at least a metal layer. In order for the layer having the heat ray reflection function to improve the transparency, the layer having the heat ray reflection function preferably has a dielectric layer, a metal layer, and a dielectric layer sequentially stacked.

The metal layer can employ metal such as gold, silver, copper, aluminum, nickel, palladium, or tin, or an alloy thereof. Above all, a thin film of silver or its alloy that hardly absorbs a visible light ray is preferable. Such a metal layer can be formed by a vapor-phase growth method such as a vacuum deposition method, a sputtering method, an ion plating method, a thermal CVD method, a plasma CVD method, or a photo-CVD method, or a plating method or the like.

The dielectric layer can employ a metal oxide or a metal nitride, such as titanium oxide, tantalum oxide, zirconium oxide, zinc oxide, tin oxide, silicon oxide, indium oxide, titanium oxynitride, niobium oxide, indium tin oxide (ITO), titanium nitride, silicon oxynitride, or silicon nitride. Such a dielectric layer can be formed by a vapor-phase growth method such as a vacuum deposition method, a sputtering method, an ion plating method, a thermal CVD method, a plasma CVD method, or a photo-CVD method, or an application method such as a sol-gel method.

As the layer having the gas barrier function, an inorganic thin film or a resin layer is given.

As an inorganic material included in the inorganic thin film, an inorganic metal compound such as an oxide or a halide of silicon, aluminum, titanium, selenium, magnesium, barium, zinc, tin, indium, calcium, tantalum, zirconium, thorium, thallium, or the like alone or a mixture thereof, or ceramic such as glass is given.

As an organic material included in the resin layer, a synthetic resin such as vinylidene chloride-vinyl chloride copolymer, vinylidene chloride-acrylonitrile copolymer, vinylidene chloride-acrylic copolymer, biaxially-stretched stretched polypropylene (OPP), unstretched polypropylene (CPP), cyclic polyolefin, polychlorotrifluoroethylene (PCTFE), tetrafluoroethylene-hexafluoropropylene copolymer (FEP), or tetrafluoroethylene-perfluoroalkylvinylether copolymer (PFA) is given.

As the layer having the planar heat generation function, the one in which an electrically conductive circuit or a copper wire serving as a heat generator is disposed, a heat generation layer in which electrically conductive powder of carbon or the like is dispersed in a binder resin such as synthetic rubber, or the like is given.

The electrically conductive circuit, the copper wire, or the heat generation layer serving as the layer having the planar heat generation function is connected to an electrode and the electrically conductive circuit, the copper wire, or the heat generation layer is sandwiched between insulation layers such as the plastic film and the adhesive layer. The electrically conductive circuit can be formed by a known method, for example by bonding a metal foil onto a plastic film and then etching the metal foil, by depositing metal, by sputtering metal, or by printing an electrically conductive paste.

The functional laminated plate according to this embodiment may include, in addition to the aforementioned functional layer, a printed layer (print layer) or another layer on the outermost layer or between the layers. The print layer is provided for hiding a structure existing below the functional laminated plate or for displaying necessary information depending on the purpose of the use of the functional laminated plate according to this embodiment, and may be formed by directly printing an outline, a letter, a ruled line, or a pattern on the plastic film included in the laminated plate or by printing it on a film or a sheet of paper or the like that is suitable for printing.

The functional laminated plate according to this embodiment can be manufactured by bonding the plastic film with the functional layer to a plastic film through the adhesive layer, by bonding the plastic film on which the adhesive layer and the functional layer are provided sequentially and the plastic film on which the adhesive layer is provided to each other, or by bonding the plastic film, the functional layer (in the case where the functional layer can be handled alone), and the plastic film to each other through the adhesive layer, for example. As for a method of forming the adhesive layer, a method is given in which the constituent of a thermosetting resin or an ionizing radiation curable resin is dissolved or diffused in an appropriate solvent to prepare an application liquid or the constituent of the adhesive layer is mixed without the use of a solvent to prepare an application liquid, and the application liquid is applied on a plastic film by a known method such as a roll coating method, a bar coating method, a spray coating method, or an air knife coating method and the plastic film is heated or irradiated with an ionizing radiant beam. The amount of the ionizing radiation is approximately 500 to 1500 mJ.

The functional laminated plate according to this embodiment can be subjected to die cutting processing into a desired shape in accordance with the intended purpose. For example, the die cutting processing can be performed by a conventionally known method using a die cutter including a Thompson blade (steel cutting rule) or the like.

Such die cutting processing performed using the die cutter allows for simultaneous processing on plural pieces or a large area, and the process time can be reduced even when the functional laminated plate has larger thickness, and the production efficiency can be improved as compared with laser cutting processing. Furthermore, as described above, because of the particular structure including the adhesive layer with the Martens hardness after the curing in the particular range, the crack of the functional laminated plate can be prevented during the die cutting and separation or floating at the interface between the plastic film or the functional layer and the adhesive layer will not occur.

The functional laminated plate of this embodiment can be used as a surface protection sheet of a liquid crystal display device, a plasma display device, an EL display device, or the like in the case where the functional layer has the electromagnetic wave shielding function. Furthermore, in the case where the functional layer has the heat ray reflection function, the functional laminated plate can be fitted into a frame (for example, a frame of a net window) and installed on a rail of the window to be used. In the case where the functional layer has the gas barrier function, the functional laminated plate can be used as a gas barrier case by being assembled in a box shape. In the case where the functional layer has the planar heat generation function, the functional laminated plate can be fitted into a frame and used as a thin heater.

### Embodiment 2

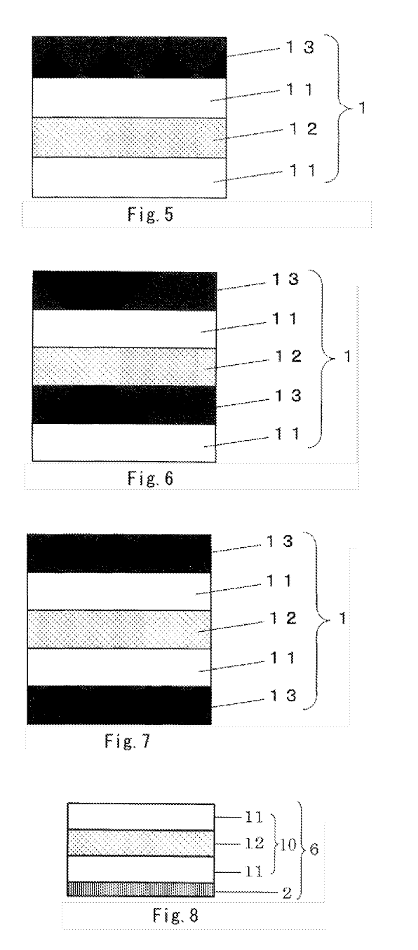

A functional laminated plate according to Embodiment 2 includes a functional layer on at least one surface of a plastic film on the outermost surface. Examples thereof are shown in FIG. 5 to FIG. 7. FIG. 5 and FIG. 6 show the case where the functional layer 13 is provided on one outermost surface of the functional laminated plate 1, and FIG. 7 shows the case where the functional layer 13 is provided on each outermost surface of the functional laminated plate 1. In addition to the functional layer 13 provided on the outermost layer, another functional layer 13 may be provided inside the laminated plate as shown in FIG. 6. Although FIG. 5 to FIG. 7 depict the laminated plate including the two plastic films 11, the laminated plate may include three or more plastic films as shown in FIG. 3 or FIG. 4 according to Embodiment 1. Alternatively, the functional layer can be attached to the uppermost plastic film through the adhesive layer 12.

As the functional layer according to this embodiment, a layer having a function selected from the light reflection function, the light transmission control function, and the antifogging function is given.

The layer with the light reflection function may be a white layer, a metal thin-film layer, or the like as long as light (including an infrared ray) can be reflected.

As the white layer, a foamed white film, a white resin layer including titanium dioxide or barium sulfate as a white pigment, or the like can be used.

As the metal thin-film layer, for example, a metal thin film of silver, aluminum, or the like which is deposited by a physical vapor deposition method (PVD), such as a vacuum deposition method, an ion plating method, a sputtering method, or an ion beam deposition method can be used. The thickness of the metal thin-film layer is preferably 50 nm or more and 1000 nm or less, and more favorably 80 nm or more and 300 nm or less.

A surface not provided with the layer having the light reflection function (a surface provided with the adhesive layer, or one surface of the other plastic film) can be provided with a similar layer having the light reflection function or another functional layer. For example, in order to reflect the light which has not been reflected on the layer having the light reflection function, a layer with the light reflection function can be provided. In order to absorb the light which has not been reflected on the layer having the light reflection function, a colored resin layer of black or the like can be provided. Alternatively, a light diffusing function may be provided to the other surface for the use as a reflection screen.

By the combination between the layer having the light reflection prevention function and the layer having the light reflection function, the visible light can be transmitted while the infrared ray is reflected.

As the layer having the light reflection prevention function, a refractive index control layer, an unevenness-imparting layer, or the like can be used so long as the light reflection can be prevented.

The refractive index control layer includes a stack of films with different refractive indices, a single film with a low refractive index or a high refractive index, or the like, and prevents or suppresses the occurrence of reflection light at an interface of the air, the plastic film, the refractive index control layer, or the like.

As such a refractive index control layer, a metal thin-film layer, a resin layer to which an appropriately selected binder resin or a binder resin including a pigment is added, or the like is given.

As the pigment for controlling the refractive index, for example, silicon oxide, aluminum oxide, antimony oxide, tin oxide, titanium oxide, zirconium oxide, tantalum oxide, or the like can be used. The average particle diameter of the pigment is preferably 0.1 μm or less. By setting the average particle diameter to 0.1 μm or less, the random reflection of the light at the refractive index control layer can be prevented and the decrease in transparency can be prevented.

As the metal used for the refractive index control layer, a metal oxide or a metal nitride, such as titanium oxide, tantalum oxide, zirconium oxide, zinc oxide, tin oxide, silicon oxide, indium oxide, titanium oxynitride, titanium nitride, silicon oxynitride, or silicon nitride can be used. Such a metal thin film can be formed by a method similar to the method for forming the metal thin-film layer of the layer having the light reflection function.

By providing the unevenness-imparting layer on the outermost surface of the functional laminated plate, the reflection on the surface of the plastic film can be prevented. Such an unevenness-imparting layer can be formed by a binder resin and a pigment, or by performing blasting processing or the like on the plastic film, for example.

The layer having the antifogging function prevents the fogging due to a water droplet or the like. As such a layer having the antifogging function, a hydrophilic layer, a water repellent layer, or the like is given.

For the hydrophilic layer, a hydrophilic polymer is preferably used. The main chain structure of the hydrophilic polymer is not particularly limited. The preferred main chain structures include an acrylic resin, a methacryl resin, a polyvinyl acetal resin, a polyurethane resin, a polyurea resin, a polyimide resin, a polyamide resin, an epoxy resin, a polystyrene resin, a novolac type phenol resin, a polyester resin, or the like, a natural product cyclic polymer resin such as cellulose, amylose or chitosan, synthetic rubber, natural rubber, and the like. In particular, an acrylic resin and a methacryl resin are preferable. The hydrophilic polymer may be copolymer.

As the hydrophilic group, a functional group such as a carboxyl group, an alkali metal salt of a carboxyl group, a sulfonic acid group, an alkali metal salt of a sulfonic acid group, a hydroxy group, an amide group, a carbamoyl group, a sulfonic amide group, a sulfamoyl group, or the like is preferably used. There groups may be located at any position in the polymer. In a preferred polymer structure, plural groups are linked to the polymer main chain directly or via a linking group, or linked to the polymer side chain or a graft side chain.

The hydrophilic layer may be formed by mixing an anatase type titanium oxide, a rutile type titanium oxide, a brookite type titanium oxide, zinc oxide, tin oxide, ferric oxide, dibismuth trioxide, tungsten trioxide, strontium titanate, or the like with an optical catalyst function into an inorganic binder.

Such a hydrophilic layer preferably has a contact angle on water of 20° or less. Furthermore, a surface of the hydrophilic layer preferably has unevenness. With such a hydrophilic layer, the antifogging effect can be exhibited even with a water droplet on the surface because the water droplet spreads out instantly.

The water repellent layer can be formed using an acrylic-based resin, an epoxy-based resin, a silicone-based resin, a fluorine-based resin, or the like. As the hydrophobic group, a phenyl group, an alkyl group, a fluoroalkyl group, an acetoxy group, an oxime group, a methoxy group, an amide group, a propenoxy group, a methyl group, or the like is given.

The water repellent layer preferably has a contact angle on water of 90° or more. With such a water repellent layer, the antifogging effect can be exhibited even with a water droplet on the surface because the water droplet drops off.

The layer having the antifogging function can have a laminated structure including a hydrophilic layer and a porous water repellent layer. Even in the case where the hydrophilic layer contains water to cause the surface thereof to be sticky, the provision of the porous water repellent layer on the hydrophilic layer does not cause a trouble due to the stickiness because the hydrophilic layer is not located as the uppermost layer. Furthermore, when a water droplet is attached to the surface of the water repellent layer, the water droplet easily leaks into the hydrophilic layer through the pore part of the water repellent layer, so that the water droplet does not remain on the surface of the layer having the antifogging function; thus, the antifogging effect is improved.

The functional laminated plate according to this embodiment may include a printed layer (print layer) or another layer as the layer on the outermost surface or the interlayer in a manner similar to Embodiment 1.

The laminated plate according to this embodiment is manufactured by bonding at least two plastic films to each other through the adhesive layer. For example, the adhesive layer is formed on one plastic film and the applied surface is adhered to the other plastic film, and then the adhesive layer is cured by heating or irradiation with an ionizing radiant beam. As the method for forming the adhesive layer, a method similar to the method in Embodiment 1 can be employed.

The functional layer can be formed by, in a manner similar to the adhesive layer, applying an application liquid including a material of the functional layer on the plastic film by a known method such as a roll coating method, a bar coating method, a spray coating method, or an air knife coating method, and performing thereon heating or irradiation with an ionizing radiant beam as necessary. These functional layers may include an additive such as a leveling agent, a UV absorbent, or an antioxidant.

The laminated plate according to this embodiment includes the material suitable for the use in a surface protection sheet for a display device; the laminated plate can be used for another purpose in addition to the use for the surface protection sheet by being cut into a desired shape depending on the purpose.

The die cutting processing can be performed by a known method similar to Embodiment 1 using, for example, a die cutter including a Thompson blade (steel cutting rule), or the like, and a similar effect can be obtained.

When the functional layers of the functional laminated plate of this embodiment have the light reflection function and the light transmission control function, the functional laminated plate can be used as the surface protection sheet for a liquid crystal display device, a plasma display device, an EL display device, or the like. When the metal thin-film layer is used as the layer having the light reflection function, the functional laminated plate can be used as an unbreakable mirror. When the functional layer has the antifogging function, the functional laminated plate can be fitted into a frame (such as a frame of a net window) and installed on a rail of the window to be used. Alternatively, the functional laminated plate can be used as an antifogging case by being assembled into a machine box shape.

### Embodiment 3

In Embodiment 3 that describes a transparent electrically conductive laminated plate for a touch panel, a transparent electrically conductive layer is provided on at least one surface of a transparent laminated plate. Specific examples thereof are shown in FIG. 8 to FIG. 10.

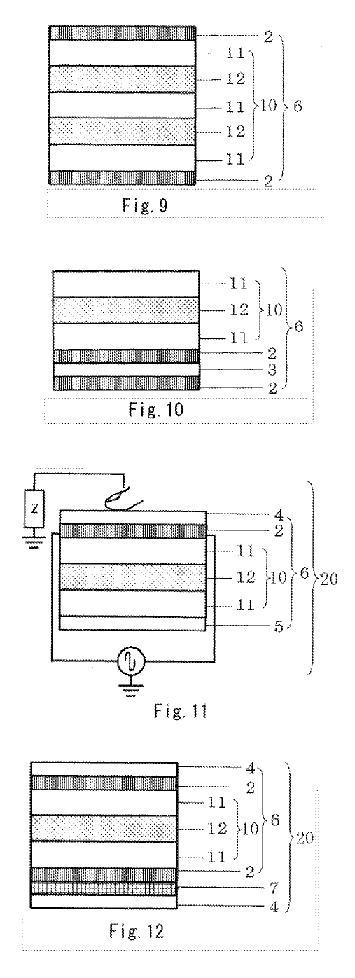

FIG. 8 depicts a transparent electrically conductive laminated plate 6 for a touch panel including a transparent electrically conductive layer 2 on one surface of a transparent laminated plate 10, which can be used for an upper electrode or a lower electrode of a resistive touch panel or for a member of an electrostatic capacitive touch panel of a surface type. FIG. 9 depicts the transparent electrically conductive laminated plate 6 for a touch panel including the transparent electrically conductive layer 2 on each surface of the transparent laminated plate 10, which can be used for an electrostatic capacitive touch panel of a projection type, or an electrostatic capacitive touch panel of a surface type having the electromagnetic wave shielding function. FIG. 10 depicts the transparent electrically conductive laminated plate 6 for a touch panel including two transparent electrically conductive layers 2 on one surface of the transparent laminated plate 10 through an insulation layer 3, which can be used for an electrostatic capacitive touch panel of the projection type.

For the transparent electrically conductive layer, a widely known transparent electrically conductive material can be used; for example, a transparent electrically conductive material such as indium oxide, tin oxide, indium tin oxide (ITO), gold, silver, or palladium can be used. These can be formed on one of or both surfaces of the laminated plate by a vacuum deposition method, a sputtering method, an ion plating method, a solution application method, or the like. Alternatively, an organic electrically conductive material can be used for forming the transparent electrically conductive layer.

The thickness of the transparent electrically conductive layer depends on the material to be used, but is set so that the surface resistivity is 1000Ω or less, preferably 500Ω or less. In consideration of the economic efficiency, a thickness of 10 nm or more, preferably 20 nm or more and 80 nm or less, and more preferably 70 nm or less is preferable.

The transparent electrically conductive layer is formed using a pattern obtained by etching, as necessary. For example, in the case of the transparent electrically conductive laminated plate for the electrostatic capacitive touch panel of the projection type depicted in FIG. 9 or FIG. 10, one transparent electrically conductive layer is formed as an X electrode for recognizing X coordinate, and the other transparent electrically conductive layer is formed as a Y electrode for recognizing Y coordinate. In the case of the transparent electrically conductive laminated plate for a resistive touch panel of a multi-touch type, the electrically conductive layers are formed in long stripes with intervals. When they are incorporated into the touch panel, the upper electrode and the lower electrode are arranged so that their stripe directions intersect with each other.

Note that a refractive index control layer is preferably provided between the plastic film and the transparent electrically conductive layer. In the case of the electrostatic capacitive touch panel of the projection type or the resistive touch panel of the multi-touch type, the provision of the refractive index control layer formed from a material whose refractive index is close to that of the material of the electrode between the plastic film and the transparent electrically conductive layer makes the electrode pattern less visually prominent. For the refractive index control layer, the material described in Embodiment 2 can be used.

The transparent electrically conductive laminated plate for a touch panel according to the present invention is manufactured by bonding at least two plastic films to each other through the adhesive layer. For example, the adhesive layer is formed on one plastic film and the applied surface is adhered to the other plastic film, and then the adhesive layer is cured by heating or irradiation with an ionizing radiant beam. As the method for forming the adhesive layer, a method similar to the method in Embodiment 1 and Embodiment 2 can be employed. The timing when the transparent electrically conductive layer is formed may be either before or after the bonding of the plastic films to each other.

The transparent electrically conductive laminated plate for a touch panel preferably includes a hard coat layer on the surface not provided with the transparent electrically conductive layer or between the plastic film and the transparent electrically conductive layer. The provision of the hard coat layer can increase the stiffness further and produces less damage. The hard coat layer is preferably formed using a thermosetting resin or an ionizing radiation curable resin, and preferably has a thickness of 2 to 15 μm from the viewpoint of the die cutting processing.

In the case of the electrostatic capacitive touch panel, a protection film is preferably formed on the transparent electrically conductive film from the viewpoint of protection against the damage. As the protection film, an inorganic thin film formed of an inorganic oxide such as silica by sputtering or the like is given. Such an inorganic thin film can be used as the insulation layer 3 depicted in FIG. 10.

The transparent electrically conductive laminated plate for a touch panel of this embodiment can be subjected to the die cutting processing into a desired shape in accordance with the purpose in a manner similar to Embodiments 1 and 2, and a similar effect can be obtained. That is, crack does not occur in the die cutting processing, and separation or floating does not occur at the interface between the plastic film and the adhesive layer.

Next, an embodiment of a touch panel according to the present invention is described. A touch panel according to the present invention is characterized by including the aforementioned transparent electrically conductive laminated plate for a touch panel. As the touch panel, there are mainly an electrostatic capacitive touch panel and a resistive touch panel, and the present invention can be used to both of them. An appropriate transparent electrically conductive laminated plate is selected in accordance with the type of the touch panel. The touch panel of each type is described below.

The electrostatic capacitive touch panel is classified into the surface type (Surface Capacitive) and the projection type (Projected Capacitive).

An embodiment of an electrostatic capacitive touch panel 20 of the surface type is depicted in FIG. 11. In the depicted touch panel, a basic circuit is connected to the transparent electrically conductive laminated plate 6 in which the transparent electrically conductive layer 2 and a protection layer 4 are provided on one surface of the transparent base (transparent laminated plate) 10 and an electromagnetic wave shielding layer 5 is provided on the other surface. The transparent base 10 is a transparent laminated plate in which two plastic films 11 are stacked through the adhesive layer 12.

The basic circuit is generally a constant-voltage circuit in which a sine wave is used as a driving signal and minute current is supplied to four corners at the same time in a transparent electrically conductive layer. While a person does not touch the panel, current hardly flows to the panel because the potential at the four corners is the same. Meanwhile, when a finger touches a point, the current flowing on the panel is changed by the capacitance of a human body. The amount of change in current at this time is inversely proportional to the distance from the four corners to the touched point. Then, the current is converted into voltage to determine the coordinate.

An embodiment of a structure of the electrostatic capacitive touch panel 20 of the projection type is depicted in FIG. 12. In the depicted touch panel, the transparent electrically conductive layer 2 and the protection layer 4 are provided on one surface of the transparent base 10 and the transparent electrically conductive layer 2, a leading electrode line 7, and the protection layer 4 are provided on the other surface. The transparent base 10 is the transparent laminated plate in which the two plastic films 11 are stacked through the adhesive layer 12. In the electrostatic capacitive touch panel 20 depicted in FIG. 12, the transparent electrically conductive laminated plate 6 may be replaced by the transparent electrically conductive laminated plate 6 depicted in FIG. 9 or FIG. 10.

In the electrostatic capacitive touch panel of the projection type, one transparent electrically conductive layer is formed as an X electrode for recognizing X coordinate, and the other transparent electrically conductive layer is formed as a Y electrode for recognizing Y coordinate. The coordinate at the touched point is determined by detecting the change in voltage between the X and Y electrodes caused by approach of the finger.

In the resistive touch panel, the upper electrode and the lower electrode, each including the transparent electrically conductive layer on the transparent base, are arranged through spacers so that the transparent electrically conductive layers face each other.

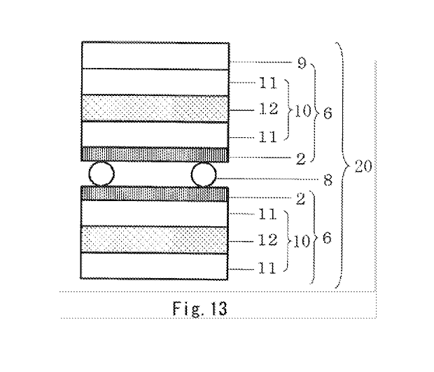

An embodiment of a structure of the resistive touch panel 20 is depicted in FIG. 13. In the depicted touch panel, an upper electrode including the transparent electrically conductive layer 2 on one surface of the transparent base 10 and a hard coat layer 9 on the other surface, and a lower electrode including the transparent electrically conductive layer 2 on the other surface of the transparent base 10 are arranged through spacers 8 so that the transparent electrically conductive layers 2 of the upper electrode and the lower electrode face each other.

In the resistive touch panel, the coordinate of the touched point is determined based on the value of voltage when the upper electrode and the lower electrode at the touched point are brought into contact with each other for current conduction. In the resistive touch panel of the multi-touch type, the upper electrode and the lower electrode are arranged so that their stripe directions intersect with each other.

Although the structure of the touch panel of the present invention described so far is similar to that of the conventional electrostatic capacitive and resistive touch panels, since a transparent laminated plate formed by bonding at least two transparent plastic films to each other through an adhesive layer with a Martens hardness of 260 N/mm² or less is used as the transparent base, the touch panel can have stiffness and tactile sensation (touch sensitivity) in spite of lightweight and have no risk of glass scattering during handling.

### EXAMPLES

The present invention is further described hereinafter with Examples. Note that “part” and “%” are based on weight unless otherwise specified.

### 1. Functional Laminated Plate (First Aspect)

### Example 1

A titanium oxide layer (dielectric layer: first layer) with a thickness of 15 nm was formed on one surface of a transparent polyester film A (COSMOSHINE A4300: TOYOBO CO., LTD.) with a thickness of 188 μm, a silver layer (metal layer: second layer) with a thickness of 12 nm was formed thereon, and a titanium oxide layer (dielectric layer: third layer) with a thickness of 25 nm was further formed thereon, thereby forming a heat ray reflection layer. The three layers were formed by a sputtering method under vacuum (5×100⁻⁵ torr). The heat ray reflection layer also had an electromagnetic wave shielding function because of having the silver layer.

A hard coat layer application liquid having the following composition was applied so as to have a thickness of 5 μm on a surface of the polyester film A on the side opposite to the heat ray reflection layer by a bar coating method and irradiated with a UV ray, thereby fabricating a transparent polyester film having the heat ray reflection layer and the hard coat layer.

<Hard coat layer application liquid>

| | |
|---|---|
| Ionizing radiation curable resin | 58 parts |
| (DIABEAM UR6530: MITSUBISHI RAYON CO., LTD.) | |
| Photopolymerization initiator | 1.8 parts |
| (IRGACURE 651: CIBA JAPAN) | |
| Methyl ethyl ketone | 80 parts |
| Toluene | 60 parts |
| Ethyl cellosolve | 7 parts |

Next, an adhesive layer application liquid S1 having the following composition was applied so as to have a thickness of 10 μm onto the heat ray reflection layer of the transparent polyester film A by a bar coating method. Subsequently, a transparent polyester film B (COSMOSHINE A4300: TOYOBO CO., LTD.) with a thickness of 188 μm was adhered onto the adhesive layer and irradiation with a UV ray was performed, thereby fabricating a functional laminated plate of Example 1.

<Adhesive layer application liquid S1>

| | |
|---|---|
| Ionizing radiation curable resin | 60 parts |
| (NK-OLIGO U-200PA: SHIN-NAKAMURA CHEMICAL | |
| CO., LTD.) | |
| Hydroxyethyl methacrylate | 35 parts |
| 2-hydroxyethyl acrylate | 5 parts |
| Photopolymerization initiator | 5 parts |
| (IRGACURE 184: CIBA JAPAN) | |

### Example 2

A functional laminated plate of Example 2 was fabricated in a manner similar to Example 1 except that the adhesive layer application liquid was replaced by the following adhesive layer application liquid S2.

<Adhesive layer application liquid S2>

| | |
|---|---|
| Ionizing radiation curable resin | 30 parts |
| (NK-OLIGO U-200PA: SHIN-NAKAMURA CHEMICAL | |
| CO., LTD.) | |
| Ionizing radiation curable resin | 30 parts |
| (ARONIX M-6100: TOAGOSEI CO., LTD.) | |
| Hydroxyethyl methacrylate | 40 parts |
| photopolymerization initiator | 5 parts |
| (IRGACURE 184: CIBA JAPAN) | |

### Example 3

A functional laminated plate of Example 3 was fabricated in a manner similar to Example 1 except that the adhesive layer application liquid was replaced by the following adhesive layer application liquid S3.

<Adhesive layer application liquid S3>

| | |
|---|---|
| Ionizing radiation curable resin | 30 parts |
| (KAYARAD R-115: NIPPON KAYAKU CO., LTD.) | |
| Ionizing radiation curable resin | 30 parts |
| (ARONIX M-6100: TOAGOSEI CO., LTD.) | |
| Hydroxyethyl methacrylate | 40 parts |
| Photopolymerization initiator | 5 parts |
| (IRGACURE 184: CIBA JAPAN) | |

### Example 4

A functional laminated plate of Example 4 was fabricated in a manner similar to Example 1 except that the adhesive layer application liquid was replaced by the following adhesive layer application liquid S4.

<Adhesive layer application liquid S4>

| | |
|---|---|
| Ionizing radiation curable resin | 60 parts |
| (KAYARAD R-115: NIPPON KAYAKU CO., LTD.) | |
| Hydroxyethyl methacrylate | 40 parts |
| Photopolymerization initiator | 5 parts |
| (IRGACURE 184: CIBA JAPAN) | |

### Example 5

A functional laminated plate of Example 5 was fabricated in a manner similar to Example 1 except that each of the transparent polyester film A and the transparent polyester film B was replaced by a polyester film with a thickness of 250 μm (COSMOSHINE A4300: TOYOBO CO., LTD.).

### Example 6

A functional laminated plate of Example 6 was fabricated in a manner similar to Example 1 except that each of the transparent polyester film A and the transparent polyester film B was replaced by a polyester film with a thickness of 100 μm (COSMOSHINE A4300: TOYOBO CO., LTD.).

### Example 7

A polyester film having a heat ray reflection layer and a hard coat layer was fabricated in a manner similar to Example 1 using a transparent polyester film C (COSMOSHINE A4300: TOYOBO CO., LTD.) with a thickness of 250 μm instead of the transparent polyester film A. Next, the adhesive layer application liquid S1 similar to that of Example 1 was applied by a bar coating method so as to have a thickness of 10 μm on the surface of the polyester film on the heat ray reflection layer side and on one surface of a transparent polyester film D (COSMOSHINE A4300: TOYOBO CO., LTD.) with a thickness of 188 μm; thus, two adhesive films were obtained. Next, the obtained two adhesive films and a transparent polyester film E (COSMOSHINE A4300: TOYOBO CO., LTD.) with a thickness of 250 μm were adhered to each other so as to obtain the structure of hard coat layer/film C/heat ray reflection layer/adhesive layer/film D/adhesive layer/film E. Then, irradiation with a UV ray was performed to cure the adhesive layers, thereby fabricating the functional laminated plate of Example 7.

### Example 8

A functional laminated plate of Example 8 was fabricated in a manner similar to Example 7 except that the transparent polyester film D was replaced by a transparent polyester film (COSMOSHINE A4300: TOYOBO CO., LTD.) with a thickness of 250 μm.

### Example 9

A functional laminated plate of Example 9 was fabricated in a manner similar to Example 1 except that the adhesive layer application liquid was replaced by the following adhesive layer application liquid S5, and that the irradiation with a UV ray was not performed after the adhesive layer application liquid was applied and dried and the bonding was performed.

<Adhesive layer application liquid S5>

| | |
|---|---|
| Thermosetting resin | 90 parts |
| (TAKELAC A-606: MITSUI CHEMICALS, INC.) | |
| Curing agent | 10 parts |
| (TAKENATE A-50: MITSUI CHEMICALS, INC.) | |
| Diluting solvent | 146 parts |

### Comparative Example 1

A functional laminated plate of Comparative Example 1 was fabricated in a manner similar to Example 1 except that the adhesive layer application liquid was replaced by the following adhesive layer application liquid S6.

<Adhesive layer application liquid S6>

| | |
|---|---|
| Ionizing radiation curable resin | 50 parts |
| (KAYARAD R-115: NIPPON KAYAKU CO., LTD.) | |
| Ionizing radiation curable resin | 30 parts |
| (NK-ESTER A-TMM-3N: SHIN-NAKAMURA CHEMICAL | |
| CO., LTD.) | |
| Photopolymerizable monomer | 20 parts |
| (ACMO: KOHJIN CO., LTD.) | |
| Photopolymerization initiator | 5 parts |
| (IRGACURE 184: CIBA JAPAN) | |

### Comparative Example 2

A functional laminated plate of Comparative Example 2 was fabricated in a manner similar to Example 1 except that the adhesive layer application liquid was replaced by the following adhesive layer application liquid S7.

<Adhesive layer application liquid S7>

| | |
|---|---|
| Ionizing radiation curable resin | 100 parts |
| (NK-OLIGO U-15HA: SHIN-NAKAMURA CHEMICAL | |
| CO., LTD.) | |
| Photopolymerization initiator | 5 parts |
| (IRGACURE 184: CIBA JAPAN) | |

### Comparative Example 3

A functional laminated plate of Comparative Example 3 was fabricated in a manner similar to Example 1 except that the adhesive layer application liquid was replaced by the following adhesive layer application liquid S8.

<Adhesive layer application liquid S8>

| | |
|---|---|
| Ionizing radiation curable resin | 100 parts |
| (NK-ESTER A-TMM-3N: SHIN-NAKAMURA | |
| CHEMICAL CO., LTD.) | |
| Photopolymerization initiator | 5 parts |
| (IRGACURE 184: CIBA JAPAN) | |

### Comparative Example 4

A functional laminated plate of Comparative Example 4 was fabricated in a manner similar to Example 1 except that the adhesive layer application liquid was replaced by the following intermediate layer application liquid S9.

<Intermediate layer application liquid S9>

| | |
|---|---|
| Ionizing radiation curable resin | 90 parts |
| (NK-OLIGO U15-HA: SHIN-NAKAMURA CHEMICAL | |
| CO., LTD.) | |
| Butyl acrylate | 10 parts |
| Photopolymerization initiator | 5 parts |
| (IRGACURE 184: CIBA JAPAN) | |

### Comparative Example 5

A titanium oxide layer (dielectric layer: first layer) with a thickness of 15 nm was formed on one surface of a transparent polyester film (COSMOSHINE A4300: TOYOBO CO., LTD.) with a thickness of 250 μm, a silver layer (metal layer: second layer) with a thickness of 12 nm was formed thereon, and a titanium oxide layer (dielectric layer: third layer) with a thickness of 25 nm was further formed thereon, thereby forming a heat ray reflection layer. The three layers were formed by a sputtering method under vacuum (5×10⁻⁵ torr). Next, a hard coat layer application liquid including the following composition was applied so as to have a thickness of 5 μm on a surface thereof on a side opposite to the heat ray reflection layer and irradiation with a UV ray was performed, thereby fabricating a functional film of Comparative Example 5.

<Hard coat layer application liquid>

| | |
|---|---|
| Ionizing radiation curable resin | 58 parts |
| (DIABEAM UR6530: MITSUBISHI RAYON CO., LTD.) | |
| Photopolymerization initiator | 1.8 parts |
| (IRGACURE 651: CIBA JAPAN) | |
| Methyl ethyl ketone | 80 parts |
| Toluene | 60 parts |
| Ethyl cellosolve | 7 parts |

### Comparative Example 6

A functional film of Comparative Example 6 was fabricated in a manner similar to Comparative Example 5 except that the transparent polyester film was replaced by a transparent polyester film (COSMOSHINE A4300: TOYOBO CO., LTD.) with a thickness of 188 μm.

(1) Martens Hardness

The adhesive layer application liquids S1 to S9 of Examples 1 to 9 and Comparative Examples 1 to 4 were each applied so as to have a thickness of 10 μm on a transparent polyester film F (COSMOSHINE A4300: TOYOBO CO., LTD.) with a thickness of 188 μm by a bar coating method. A separation type film was adhered onto the adhesive layer and, for the adhesive layers using the application liquids S1-S4, S6-S9, irradiation with a UV ray was performed (the amount of the irradiation was 1000 mJ) and, for the adhesive layers using the application liquids S5, heat-drying was performed without UV irradiation. After the adhesive layer was cured, the separation type film was separated off from the adhesive layer and the hardness of the surface of the cured adhesive layer was measured by a method based on ISO-14577-1 in an atmosphere where the temperature was 20° C. and the relative humidity was 60% using micro hardness testing equipment (product name: FISCHERSCOPE HM2000, FISCHER INSTRUMENTS K.K.). Note that the measurement was performed with a maximum test weight of 1 mN. The results are listed in Table 1.

Table 1 indicates the results of measurement and evaluation on the following items for the functional laminated plates and the functional films obtained in Examples 1 to 9 and Comparative Examples 1 to 6.

(2) Processing Suitability (Separation, Floating)

Die cutting processing was performed using a die cutter (manual press, type: torque pack press TP series, AMADA CO., LTD.), and the one without separation or floating is expressed as “Good” and the one with separation or floating is expressed as “Poor”.

(3) Adhesion

The polyester film having the hard coat layer in the functional laminated plate and another member included in the functional laminated plate were separated from each other to the left and right at a separation speed of 100 mm/min in a manner similar to the T type separation test; thus, the separation force was measured. The one having required a force for separation of 10 Newtons or more per 2 mm in width is expressed as “Good” and the one having required a force for separation of less than 10 Newtons per 2 mm in width is expressed as “Poor”.

(4) Stiffness

The one that was not bent by a touch by a finger is expressed as “Excellent,” the one that is bent slightly by the touch is expressed as “Good,” and the one that is largely bent by the touch is expressed as “Poor.”

TABLE 1

| | Thickness | | | | |
|---|---|---|---|---|---|
| | of laminated | | Processing | | |
| | plate | | suitability | | |
| | (excluding | Martens | (sepa- | | |
| | hard coat | hardness | ration, | Adhe- | |
| | layer) [μm] | [N/mm²] | floating) | sion | Stiffness |
| Example 1 | 386 | 8 | Good | Good | Excellent |
| Example 2 | 386 | 20 | Good | Good | Excellent |
| Example 3 | 386 | 180 | Good | Good | Excellent |
| Example 4 | 386 | 258 | Good | Good | Excellent |
| Example 5 | 510 | 8 | Good | Good | Excellent |
| Example 6 | 210 | 8 | Good | Good | Good |
| Example 7 | 708 | 8 | Good | Good | Excellent |
| Example 8 | 770 | 8 | Good | Good | excellent |
| Example 9 | 386 | 2 | Good | Good | Excellent |
| Comparative | 386 | 270 | Poor | Good | Excellent |
| Example 1 | | | | | |
| Comparative | 386 | 354 | Poor | Good | Excellent |
| Example 2 | | | | | |
| Comparative | 386 | 397 | Poor | Good | Excellent |
| Example 3 | | | | | |
| Comparative | 386 | 330 | Poor | Poor | Excellent |
| Example 4 | | | | | |
| Comparative | 250 | — | — | — | Good |
| Example 5 | | | | | |
| Comparative | 188 | — | — | — | Poor |
| Example 6 | | | | | |

The thickness of the laminated plate in the table refers to the thickness of the base excluding the thicknesses of the hard coat layer and the other functional layers (this similarly applies to Table 2 and Table 3).

As is clear from the above results, the functional laminated plates of Examples 1 to 9 had a Martens hardness of 260 N/mm² or less; therefore, the separation or floating was able to be prevented during the die cutting processing. In particular, the functional laminated plates of Examples 1 to 5 and Example 9 had a thickness of the plastic films+the adhesive layer in the range of 250 μm to 700 μm, which provided sufficient stiffness.

The functional laminated plate of Example 1 had an adhesion strength of the adhesive layer of 15 Newtons or more per 25 mm in width. Therefore, it was not able to separate the two plastic films off from each other after the die cutting processing, and they were particularly firmly adhered to each other.

The thickness of the plastic films+the adhesive layer of the functional laminated plate of Example 6 is smaller than that of Example 1. Since the total thickness (210 μm) is relatively small, the functional laminated plate of Example 6 was slightly bent by the touch by a finger; however, the stiffness was as high as that of one plastic film with larger thickness than that (Comparative Example 5: 250 μm). This has indicated that the functional laminated plate of Example 6 has strong stiffness than one plastic film with substantially the same thickness.

The functional laminated plates of Examples 7 and 8 have larger thickness of the plastic film+the adhesive layer than that of Example 1. The larger thickness led to extremely sufficient stiffness. Note that, however, the large total thickness required a large force for die cutting processing as compared with the functional laminated plates of Examples 1 to 6.

On the other hand, the functional laminated plate of Comparative Examples 1 to 3 had the separation or floating in the die cutting processing because of having a Martens hardness of more than 260 N/mm².

The intermediate layer provided instead of the adhesive layer in the functional laminated plate of Comparative Example 4 had a Martens hardness of more than 260 N/mm² and the adhesion strength between the two plastic films was less than 10 Newtons per 25 mm in width. Accordingly, the adhesion between the plastic film and the adhesive layer was so low that the plastic film was easily separated off. Therefore, in the die cutting processing, the repelling force of the plastic film was not able to be suppressed so that the separation or floating occurred.

The functional films of Comparative Examples 5 and 6 have the heat ray reflection layer and the hard coat layer provided on one plastic film. Not having two or more plastic films and having small thickness of the plastic film, the functional films thereof did not have sufficient stiffness.

Note that an effect similar to that of the aforementioned Examples and Comparative Examples was able to be achieved even in the case where another functional layer (electromagnetic wave shielding layer, gas barrier layer, or planar heat generation layer) was provided instead of the heat ray reflection layer.

### 2. Functional Laminated Plate (Second Aspect)

### Example 10

### Light Reflection Prevention Layer: LR

A reflection prevention layer application liquid including the following composition was applied on one surface of a 188 μm-thick transparent polyester film A (COSMOSHINE A4300: TOYOBO CO., LTD.) by a bar coater method so as to have a thickness of 0.1 μm after drying, and the application liquid was dried, thereby forming a reflection prevention layer with a refractive index of 1.38 and fabricating a transparent polyester film with the reflection prevention layer.

<Reflection prevention layer application liquid>

| | |
|---|---|
| Silica sol | 200 parts |
| Porous silica microparticle dispersion liquid | 100 parts |
| (silica component: 5%, average particle diameter: 55 nm) | |
| Isopropanol | 350 parts |
| n-butanol | 350 parts |

Next, a hard coat layer application liquid including the following composition was applied so as to have a thickness of 5 μm on one surface of a transparent polyester film B (COSMOSHINE A4300: TOYOBO CO., LTD.) with a thickness of 188 μm by a bar coating method and irradiation with a UV ray was performed, thereby fabricating a transparent polyester film including the hard coat layer.

<Hard coat layer application liquid>

| | |
|---|---|
| Ionizing radiation curable resin | 58 parts |
| (DIABEAM UR6530: MITSUBISHI RAYON CO., LTD.) | |
| Photopolymerization initiator | 1.8 parts |
| (IRGACURE 651: CIBA JAPAN) | |
| Methyl ethyl ketone | 80 parts |
| Toluene | 60 parts |
| Ethyl cellosolve | 7 parts |

Next, an adhesive layer application liquid S1 including the following composition was applied so as to have a thickness of 10 μm on a surface of the transparent polyester film A on the side opposite to the reflection prevention layer by a bar coating method. Next, a surface of the transparent polyester film including the hard coat layer on the side opposite to the hard coat layer was adhered to the adhesive layer and irradiation with a UV ray was performed, thereby fabricating the functional laminated plate of Example 10.

<Adhesive layer application liquid S1>

| | |
|---|---|
| Ionizing radiation curable resin | 60 parts |
| (NK-OLIGO U-200PA: SHIN-NAKAMURA CHEMICAL | |
| CO., LTD.) | |
| Hydroxyethyl methacrylate | 35 parts |
| 2-hydroxyethyl acrylate | 5 parts |
| Photopolymerization initiator | 5 parts |
| (IRGACURE 184: CIBA JAPAN) | |

### Example 11

### Layer Having Light Reflection Function•Application

An adhesive layer application liquid S2 including the following composition was applied so as to have a thickness of 10 μm on each surface of a 188 μm-thick transparent polyester film A (COSMOSHINE A4300: TOYOBO CO., LTD.) by a bar coating method, and one surface is provided with a foamed white polyester film B (Lumirror E-60: TORAY INDUSTRIES, INC.) with a thickness of 75 μm and the other surface is provided with a transparent polyester film C(COSMOSHINE A4300: TOYOBO CO., LTD.) with a thickness of 75 μm; then, irradiation with a UV ray was performed on the transparent polyester film C side, thereby fabricating the laminated plate.

<Adhesive layer application liquid S2>

| | |
|---|---|
| Ionizing radiation curable resin | 30 parts |
| (NK-OLIGO U-200PA: SHIN-NAKAMURA CHEMICAL | |
| CO., LTD.) | |
| Photocation polymerizable oligomer | 30 parts |
| (ARONIX M-6100: TOAGOSEI CO., LTD.) | |
| Hydroxyethyl methacrylate | 40 parts |
| Photopolymerization initiator | 5 parts |
| (IRGACURE 184: CIBA JAPAN) | |

Next, barium sulfate (B-55: SAKAI CHEMICAL INDUSTRY CO., LTD.) and titanium dioxide (Ti-pure R-700: DuPont) were diffused in an urethane resin (ADEKA BONTIGHTER U-500: ADEKA CORPORATION) so that the weight ratio was barium sulfate:titanium dioxide:resin=21:9:5. Thus, a paint for a white resin layer was prepared. This paint was applied on the surfaces (outermost surfaces) of the foamed white polyester film B and of the transparent polyester film C on the outermost surface of the laminated plate so that the dried painted film had a thickness of 50 μm on each side. Thus, the functional laminated plate of Example 11 including the white resin layer (layer having light reflection function) was fabricated.

### Example 12

### Light Reflection Layer, Metal

An adhesive layer application liquid S3 including the following composition was applied so as to have a thickness of 10 μm on a surface of a transparent polyester film A (COSMOSHINE A4300: TOYOBO CO., LTD.) with a thickness of 188 μm by a bar coating method, and one surface is provided with a foamed white polyester film B (Lumirror E-60: TORAY INDUSTRIES, INC.) with a thickness of 75 μm and the other surface is provided with a transparent polyester film C(COSMOSHINE A4300: TOYOBO CO., LTD.) with a thickness of 75 μm; then, irradiation with a UV ray was performed on the transparent polyester film C side, thereby fabricating the laminated plate.

<Adhesive layer application liquid S3>

| | |
|---|---|
| Ionizing radiation curable resin | 30 parts |
| (KAYARAD R-115: NIPPON KAYAKU CO., LTD.) | |
| Ionizing radiation curable resin | 30 parts |
| (ARONIX M-6100: TOAGOSEI CO., LTD.) | |
| Hydroxyethyl methacrylate | 40 parts |
| Photopolymerization initiator | 5 parts |
| (IRGACURE 184: CIBA JAPAN) | |

Next, a 12-nm-thick aluminum layer was provided on one surface of the transparent polyester film C of the laminated plate by a sputtering method under vacuum (5×10⁻⁵ torr), thereby forming a metal layer (layer having light reflection function) and fabricating a functional laminated plate of Example 12.

### Example 13

### Antifogging Function

A functional laminated plate of Example 13 was fabricated in a manner similar to Example 10 except that the polyester film having the hard coat layer of Example 10 was replaced by a polyester film with an antifogging layer and that the adhesive layer application liquid was replaced by the following adhesive layer application liquid S4. The polyester film having the antifogging layer was fabricated in a manner that the following hydrophilic layer application liquid was applied and dried so as to have a thickness of 20 μm after drying on one surface of a polyester film (COSMOSHINE A4300: TOYOBO CO., LTD.) and irradiation with a UV ray was performed with a superhigh pressure mercury lamp to form a hydrophilic layer, and then the following surface protection layer application liquid was applied on the hydrophilic layer by 18 g/m² and dried to form a surface protection layer.

<Hydrophilic layer application liquid>

| | |
|---|---|
| Ethylene oxide modified diacrylate | 20 parts |
| (NEW FRONTIER PE-600: DAI-ICHI KOGYO SEIYAKU | |
| CO., LTD.) | |
| Photopolymerization initiator | 5 parts |
| (IRGACURE 184: CIBA JAPAN) | |
| Ethanol | 4 parts |

<Surface protection layer application liquid>

| | |
|---|---|
| Tetraethoxysilane | 20 parts |
| (tetraethyl orthosilicate: WAKO PURE CHEMICAL | |
| INDUSTRIES, LTD.) | |
| Acetylene glycol | 3 parts |
| (surfynol 465: AIR PRODUCTS AND CHEMICALS, INC.) | |
| Ethanol | 20 parts |
| 0.01-normal hydrochloric acid aqueous solution | 5 parts |

These are all mixed and stirred for 10 hours at room temperature for reaction, and this is used as the application liquid.

<Adhesive layer application liquid S4>

| | |
|---|---|
| Ionizing radiation curable resin | 60 parts |
| (KAYARAD R-115: NIPPON KAYAKU CO., LTD.) | |
| Hydroxyethyl methacrylate | 40 parts |
| Photopolymerization initiator | 5 parts |
| (IRGACURE 184: CIBA JAPAN) | |

### Example 14

A functional laminated plate of Example 14 was fabricated in a manner similar to Example 10 except that each of the transparent polyester film A and the transparent polyester film B was replaced by a polyester film (COSMOSHINE A4300: TOYOBO CO., LTD.) with a thickness of 250 μm.

### Example 15

A functional laminated plate of Example 15 was fabricated in a manner similar to Example 10 except that each of the transparent polyester film A and the transparent polyester film B was replaced by a polyester film (COSMOSHINE A4300: TOYOBO CO., LTD.) with a thickness of 100 μm.

### Example 16

A polyester film having a reflection prevention layer was fabricated in a manner similar to Example 10 using a transparent polyester film C(COSMOSHINE A4300: TOYOBO CO., LTD.) with a thickness of 250 μm instead of the transparent polyester film A. Next, the adhesive layer application liquid S1 similar to that of Example 10 was applied so as to have a thickness of 10 μm on one surface of a transparent polyester film D (COSMOSHINE A4300: TOYOBO CO., LTD.) with a thickness of 188 μm by a bar coating method, and the surface on which adhesive layer application liquid S1 was applied was adhered to a surface of the transparent polyester film C on a side opposite to the reflection prevention layer.

Next, a transparent polyester film having a hard coat layer was fabricated by forming a hard coat layer on one surface of a transparent polyester film E (COSMOSHINE A4300: TOYOBO CO., LTD.) with a thickness of 250 μm in a manner similar to Example 10. Next, the adhesive layer application liquid S1 of Example 10 was applied so as to have a thickness of 10 μm by a bar coating method on a surface opposite to the hard coat layer, and the surface on which the adhesive layer application liquid S1 was applied was adhered so as to obtain the structure of hard coat layer/film E/adhesive layer/film D/adhesive layer/film C/reflection prevention layer. Then, the irradiation with a UV ray was performed to cure the adhesive layer, thereby fabricating the functional laminated plate of Example 16.

### Example 17

A functional laminated plate of Example 17 was fabricated in a manner similar to Example 16 except that the transparent polyester film D was replaced by a transparent polyester film (COSMOSHINE A4300: TOYOBO CO., LTD.) with a thickness of 250 μm.

### Example 18

A functional laminated plate of Example 18 was fabricated in a manner similar to Example 10 except that the adhesive layer application liquid was replaced by the following adhesive layer application liquid S5 and the irradiation with a UV ray was not performed after the adhesive layer application liquid was applied and dried and the bonding was performed.

<Adhesive layer application liquid S5>

| | |
|---|---|
| Thermosetting resin | 90 parts |
| (TAKELAC A-606: MITSUI CHEMICALS, INC.) | |
| Curing agent | 10 parts |
| (TAKENATE A-50: MITSUI CHEMICALS, INC.) | |
| Diluting solvent | 146 parts |

### Comparative Example 7

A functional laminated plate of Comparative Example 7 was fabricated in a manner similar to Example 10 except that the adhesive layer application liquid was replaced by the following adhesive layer application liquid S6.

<Adhesive layer application liquid S6>

| | |
|---|---|
| Ionizing radiation curable resin | 50 parts |
| (KAYARAD R-115: NIPPON KAYAKU CO., LTD.) | |
| Ionizing radiation curable resin | 30 parts |
| (NK-ESTER A-TMM-3N: SHIN-NAKAMURA CHEMICAL | |
| CO., LTD.) | |
| Photocation photopolymerizable monomer | 20 parts |
| (ACMO: KOHJIN CO., LTD.) | |
| Photopolymerization initiator | 5 parts |
| (IRGACURE 184: CIBA JAPAN) | |

### Comparative Example 8

A functional laminated plate of Comparative Example 8 was fabricated in a manner similar to Example 10 except that the adhesive layer application liquid was replaced by the following adhesive layer application liquid S7.

<Adhesive layer application liquid S7>

| | |
|---|---|
| Ionizing radiation curable resin | 100 parts |
| (NK-OLIGO U-15HA: SHIN-NAKAMURA CHEMICAL | |
| CO., LTD.) | |
| Photopolymerization initiator | 5 parts |
| (IRGACURE 184: CIBA JAPAN) | |

### Comparative Example 9

A functional laminated plate of Comparative Example 9 was fabricated in a manner similar to Example 10 except that the adhesive layer application liquid was replaced by the following adhesive layer application liquid S8.

<Adhesive layer application liquid S8>

| | |
|---|---|
| Ionizing radiation curable resin | 100 parts |
| (NK-ESTER A-TMM-3N: SHIN-NAKAMURA | |
| CHEMICAL CO., LTD.) | |
| Photopolymerization initiator | 5 parts |
| (IRGACURE 184: CIBA JAPAN) | |

### Comparative Example 10

A functional laminated plate S9 of Comparative Example 10 was fabricated in a manner similar to Example 10 except that the adhesive layer application liquid was replaced by the following intermediate layer application liquid S9.

<Intermediate layer application liquid>

| | |
|---|---|
| Ionizing radiation curable resin | 90 parts |
| (NK-OLIGO U15-HA: SHIN-NAKAMURA | |
| CHEMICAL CO., LTD.) | |
| Butyl acrylate | 10 parts |
| Photopolymerization initiator | 5 parts |
| (IRGACURE 184: CIBA JAPAN) | |

### Comparative Example 11

A reflection prevention layer with a thickness of 0.2 μm was formed in a manner similar to Example 10 on one surface of a transparent polyester film (COSMOSHINE A4300: TOYOBO CO., LTD) with a thickness of 250 μm. Next, a hard coat layer similar to Example 10 was formed so as to have a thickness of 5 μm on a surface thereof opposite to the reflection prevention layer by a bar coating method and irradiation with a UV ray was performed, thereby fabricating a functional film of Comparative Example 11.

### Comparative Example 12

A functional film of Comparative Example 12 was fabricated in a manner similar to Comparative Example 11 except that the transparent polyester film was replaced by a transparent polyester film (COSMOSHINE A4300: TOYOBO CO., LTD.) with a thickness of 188 μm.

(1) Martens Hardness

The adhesive layer application liquids S1 to S9 of Examples 10 to 18 and Comparative Examples 7 to 12 were each applied so as to have a thickness of 10 μm on a transparent polyester film F (COSMOSHINE A4300: TOYOBO CO., LTD.) with a thickness of 188 μm by a bar coating method. A separation type film was adhered onto the adhesive layer and, for the adhesive layers using the application liquids S1-S4, S6-S9, irradiation with a UV ray was performed (the amount of the irradiation was 1000 mJ) and, for the adhesive layers using the application liquids S5, heat-drying was performed without UV irradiation. After the adhesive layer was cured, the separation type film was separated off from the adhesive layer and the hardness of the cured adhesive layer was measured in a manner similar to Examples 1 to 9. The results are listed in Table 2.

Table 2 indicates the results of measurement and evaluation performed in a manner similar to Examples 1 to 9 on the following items for the functional laminated plates and the functional films obtained in Examples 10 to 18 and Comparative Examples 7 to 12.

(2) Processing Suitability (Separation, Floating): Similar to Examples 1 to 9

(3) Adhesion

The polyester film as the uppermost layer including the functional layer and another member included in the laminated plate were separated from each other; thus, the adhesion therebetween was measured and evaluated in a manner similar to Examples 1 to 9.

(4) Stiffness: Similar to Examples 1 to 9

[Table 2]

TABLE 2

| | Thickness | | | | |
|---|---|---|---|---|---|
| | of | | | | |
| | laminated | | | | |
| | plate | | | | |
| | (excluding | | Processing | | |
| | hard | Martens | suitability | | |
| | coat layer) | hardness | (separation, | Ad- | |
| | [μm] | [N/mm²] | floating) | hesion | stiffness |
| Example 10 | 386 | 8 | Good | Good | Excellent |
| Example 11 | 358 | 20 | Good | Good | Excellent |
| Example 12 | 358 | 180 | Good | Good | Excellent |
| Example 13 | 386 | 258 | Good | Good | Excellent |
| Example 14 | 510 | 8 | Good | Good | Excellent |
| Example 15 | 210 | 8 | Good | Good | Good |
| Example 16 | 708 | 8 | Good | Good | Excellent |
| Example 17 | 770 | 8 | Good | Good | Excellent |
| Example 18 | 386 | 2 | Good | Good | Excellent |
| Comparative | 386 | 270 | Poor | Good | Excellent |
| Example 7 | | | | | |
| Comparative | 386 | 354 | Poor | Good | Excellent |
| Example 8 | | | | | |
| Comparative | 386 | 397 | Poor | Good | Excellent |
| Example 9 | | | | | |
| Comparative | 386 | 330 | Poor | Poor | Excellent |
| Example 10 | | | | | |
| Comparative | 250 | — | — | — | Good |
| Example 11 | | | | | |
| Comparative | 188 | — | — | — | Poor |
| Example 12 | | | | | |

As is clear from the above results, the functional laminated plates of Examples 10 to 18 had a Martens hardness of 260 N/mm² or less; therefore, the separation or floating was able to be prevented during the die cutting processing. In particular, the functional laminated plates of Examples 10 to 14 and Example 18 had a thickness of the plastic film+the adhesive layer in the range of 250 μm to 700 μm, which provided sufficient stiffness.

The functional laminated plate of Example 10 had an adhesion strength of the adhesive layer of 15 Newtons or more per 25 mm in width. Therefore, it was not able to separate the two plastic films off from each other after the die cutting processing, and they were particularly firmly adhered to each other.

The thickness of the plastic film+the adhesive layer of the functional laminated plate of Example 15 is smaller than that of Example 10. Since the total thickness (210 μm) is relatively small, the functional laminated plate of Example 15 was slightly bent by the touch by a finger; however, the stiffness was as high as that of one plastic film with larger thickness than that (Comparative Example 11: 250 μm). This has indicated that the functional laminated plate of Example 15 has stronger stiffness than one plastic film with substantially the same thickness.

The functional laminated plates of Examples 16 and 17 have larger thickness of the plastic film+the adhesive layer than that of Example 10. The larger thickness led to extremely sufficient stiffness. Note that, however, the large total thickness required a large force for die cutting processing as compared with the functional laminated plates of Examples 10 to 15.

Meanwhile, the functional laminated plates of Comparative Examples 7 to 9 had a Martens hardness of more than 260 N/mm²; therefore, the separation or floating occurred in the die cutting processing.

The intermediate layer provided instead of the adhesive layer in the functional laminated plate of Comparative Example 10 had a Martens hardness of more than 260 N/mm² and the adhesion strength between the two plastic films was less than 10 Newtons per 25 mm in width. Accordingly, the adhesion between the plastic film and the adhesive layer was so low that the plastic film was easily separated off. Therefore, in the die cutting processing, the repelling force of the plastic film was not able to be suppressed so that the separation or floating occurred.

The functional films of Comparative Examples 11 and 12 have the reflection prevention layer and the hard coat layer provided on one plastic film. Not having two or more plastic films and having small thickness of the plastic film, the functional films thereof did not have sufficient stiffness.

### 3. Transparent Electrically Conductive Laminated Plate (Third Aspect)

### 3. 1 Fabrication of Transparent Base (Transparent Laminated Plate or Transparent Film)

### Example 19

A hard coat layer application liquid including the following composition was applied so as to have a thickness of 5 μm on a transparent polyester film A (COSMOSHINE A4300: TOYOBO CO., LTD.) with a thickness of 188 μm by a bar coating method, and irradiation with a UV ray was performed, thereby fabricating a transparent polyester film having a hard coat layer.

<Hart coat layer application liquid>

| | |
|---|---|
| Ionizing radiation curable resin | 58 parts |
| (DIABEAM UR6530: MITSUBISHI RAYON CO., LTD.) | |
| Photopolymerization initiator | 1.8 parts |
| (IRGACURE 651: CIBA JAPAN) | |
| Methyl ethyl ketone | 80 parts |
| Toluene | 60 parts |
| Ethyl cellosolve | 7 parts |

Next, an adhesive layer application liquid S1 including the following composition was applied so as to have a thickness of 10 μm on a surface of the transparent polyester film A on a side opposite to the hard coat layer by a bar coating method. Then, a transparent polyester film B (COSMOSHINE A4300: TOYOBO CO., LTD.) with a thickness of 188 μm was adhered onto the adhesive layer and irradiation with a UV ray was performed, thereby providing a transparent laminated plate a.

<Adhesive layer application liquid S1>

| | |
|---|---|
| Ionizing radiation curable resin | 60 parts |
| (NK-OLIGO U-200PA: SHIN-NAKAMURA | |
| CHEMICAL CO., LTD.) | |
| Hydroxyethyl methacrylate | 35 parts |
| 2-hydroxyethyl acrylate | 5 parts |
| Photopolymerization initiator | 5 parts |
| (IRGACURE 184: CIBA JAPAN) | |

### Example 20

A transparent laminated plate b was obtained in a manner similar to Example 19 except that the adhesive layer application liquid was replaced by the following adhesive layer application liquid S2.

<Adhesive layer application liquid S2>

| | |
|---|---|
| Ionizing radiation curable resin | 30 parts |
| (NK-OLIGO U-200PA: SHIN-NAKAMURA CHEMICAL | |
| CO., LTD.) | |
| Ionizing radiation curable resin | 30 parts |
| (ARONIX M-6100: TOAGOSEI CO., LTD.) | |
| Hydroxyethyl methacrylate | 40 parts |
| Photopolymerization initiator | 5 parts |
| (IRGACURE 184: CIBA JAPAN) | |

### Example 21

A transparent laminated plate c was obtained in a manner similar to Example 19 except that the adhesive layer application liquid was replaced by the following adhesive layer application liquid S3.

<Adhesive layer application liquid S3>

| | |
|---|---|
| Ionizing radiation curable resin | 30 parts |
| (KAYARAD R-115: NIPPON KAYAKU CO., LTD.) | |
| Ionizing radiation curable resin | 30 parts |
| (ARONIX M-6100: TOAGOSEI CO., LTD.) | |
| Hydroxyethyl methacrylate | 40 parts |
| Photopolymerization initiator | 5 parts |
| (IRGACURE 184: CIBA JAPAN) | |

### Example 22

A transparent laminated plate d was obtained in a manner similar to Example 19 except that the adhesive layer application liquid was replaced by the following adhesive layer application liquid S4.

<Adhesive layer application liquid S4>

| | |
|---|---|
| Ionizing radiation curable resin | 60 parts |
| (KAYARAD R-115: NIPPON KAYAKU CO., LTD.) | |
| Hydroxyethyl methacrylate | 40 parts |
| Photopolymerization initiator | 5 parts |
| (IRGACURE 184: CIBA JAPAN) | |

### Example 23

A transparent laminated plate e was obtained in a manner similar to Example 19 except that each of the transparent polyester film A and the transparent polyester film B was replaced by a polyester film (COSMOSHINE A4300: TOYOBO CO., LTD.) with a thickness of 250 μm.

### Example 24

A transparent laminated plate f was obtained in a manner similar to Example 19 except that each of the transparent polyester film A and the transparent polyester film B was replaced by a polyester film (COSMOSHINE A4300: TOYOBO CO., LTD.) with a thickness of 100 μm.

### Example 25

A polyester film having a hard coat layer was fabricated in a manner similar to Example 19 using a polyester film C(COSMOSHINE A4300: TOYOBO CO., LTD.) with a thickness of 250 μm instead of the transparent polyester film A. Next, the adhesive layer application liquid S1 similar to that of Example 19 was applied so as to have a thickness of 10 μm by a bar coating method on each of a surface of the polyester film on a side opposite to the hard coat layer and one surface of a transparent polyester film D (COSMOSHINE A4300: TOYOBO CO., LTD.) with a thickness of 188 μm, thereby providing two adhesive films. Next, the two adhesion films obtained and a 250 μm-thick transparent polyester film E (COSMOSHINE A4300: TOYOBO CO., LTD.) were adhered so as to obtain the structure of hard coat layer/film C/adhesive layer/film D/adhesive layer/film E, and then irradiation with a UV ray was performed thereon for curing the adhesive layers. Thus, a transparent laminated plate g was obtained.

### Example 26

A transparent laminated plate h was obtained in a manner similar to Example 25 except that the transparent polyester film D was replaced by a transparent polyester film (COSMOSHINE A4300: TOYOBO CO., LTD.) with a thickness of 250 μm.

### Example 27

A transparent laminated plate i of Example 27 was obtained in a manner similar to Example 19 except that the adhesive layer application liquid was replaced by the following adhesive layer application liquid S5 and that the irradiation with a UV ray was not performed after the adhesive layer was applied and dried and the bonding was performed.

<Adhesive layer application liquid S5>

| | |
|---|---|
| Thermosetting resin | 90 parts |
| (TAKELAC A-606: Mitsui Chemicals, Inc.) | |
| Curing agent | 10 parts |
| (TAKENATE A-50: Mitsui Chemicals, Inc.) | |
| Diluting solvent | 146 parts |

### Comparative Example 13

A transparent laminated plate j was obtained in a manner similar to Example 19 except that the adhesive layer application liquid was replaced by the following adhesive layer application liquid S6.

<Adhesive layer application liquid S6>

| | |
|---|---|
| Ionizing radiation curable resin | 50 parts |
| (KAYARAD R-115: NIPPON KAYAKU CO., LTD.) | |
| Ionizing radiation curable resin | 30 parts |
| (NK-ESTER A-TMM-3N: SHIN-NAKAMURA | |
| CHEMICAL CO., LTD.) | |
| Photopolymerizable monomer | 20 parts |
| (ACMO: KOHJIN CO., LTD.) | |
| Photopolymerization initiator | 5 parts |
| (IRGACURE 184: CIBA JAPAN) | |

### Comparative Example 14

A transparent laminated plate k was obtained in a manner similar to Example 19 except that the adhesive layer application liquid was replaced by the following adhesive layer application liquid S7.

<Adhesive layer application liquid S7>

| | |
|---|---|
| Ionizing radiation curable resin | 100 parts |
| (NK-OLIGO U-15HA: SHIN-NAKAMURA CHEMICAL | |
| CO., LTD.) | |
| Photopolymerization initiator | 5 parts |
| (IRGACURE 184: CIBA JAPAN) | |

### Comparative Example 15

A transparent laminated plate 1 was obtained in a manner similar to Example 19 except that the adhesive layer application liquid was replaced by the following adhesive layer application liquid S8.

<Adhesive layer application liquid S8>

| | |
|---|---|
| Ionizing radiation curable resin | 100 parts |
| (NK-ESTER A-TMM-3N: SHIN-NAKAMURA CHEMICAL | |
| CO., LTD.) | |
| Photopolymerization initiator | 5 parts |
| (IRGACURE 184: CIBA JAPAN) | |

### Comparative Example 16

A transparent laminated plate m was obtained in a manner similar to Example 19 except that the adhesive layer application liquid was replaced by the following intermediate layer application liquid S9.

<Intermediate layer application liquid S9>

| | |
|---|---|
| Ionizing radiation curable resin | 90 parts |
| (NK-OLIGO U15-HA: SHIN-NAKAMURA CHEMICAL | |
| CO., LTD.) | |
| Butyl acrylate | 10 parts |
| Photopolymerization initiator | 5 parts |
| (IRGACURE 184: CIBA JAPAN) | |

### Comparative Example 17

A hard coat layer application liquid including the following composition was applied so as to have a thickness of 5 μm by a bar coating method on one surface of a transparent polyester film (COSMOSHINE A4300: TOYOBO CO., LTD.) with a thickness of 250 μm and irradiation with a UV ray was performed, thereby providing a transparent film n.

<Hard coat layer application liquid>

| | |
|---|---|
| Ionizing radiation curable resin | 58 parts |
| (DIABEAM UR6530: MITSUBISHI RAYON CO., LTD.) | |
| Photopolymerization initiator | 1.8 parts |
| (IRGACURE 651: CIBA JAPAN) | |
| Methyl ethyl ketone | 80 parts |
| Toluene | 60 parts |
| Ethyl cellosolve | 7 parts |

### Comparative Example 18

A transparent film o was obtained in a manner similar to Comparative Example 17 except that the transparent polyester film was replaced by a transparent polyester film (COSMOSHINE A4300: TOYOBO CO., LTD.) with a thickness of 188 μm.

### 3. 2 Formation of Transparent Electrically Conductive Layer

A transparent electrically conductive layer including indium tin oxide (ITO) with a thickness that provides a surface resistivity of approximately 400Ω was formed on a surface of each of the laminated plates a to m and the films n and o (on a side thereof not provided with the hard coat layer) by a sputtering method, so that transparent electrically conductive laminated plates for a touch panel of Examples 19 to 27 and Comparative Examples 13 to 16 and transparent electrically conductive films for a touch panel of Comparative Examples 17 and 18 were obtained.

(1) Martens Hardness

The adhesive layer application liquids S1 to S9 of Examples 19 to 27 and Comparative Examples 13 to 16 were applied so as to have a thickness of 10 μm on a transparent polyester film F (COSMOSHINE A4300: TOYOBO CO., LTD.) with a thickness of 188 μm by a bar coating method. A separation type film was adhered onto the adhesive layer and, for the adhesive layers using the application liquids S1-S4, S6-S9, irradiation with a UV ray was performed (the amount of the irradiation was 1000 mJ) and, for the adhesive layers using the application liquids S5, heat-drying was performed without UV irradiation. After the adhesive layer was cured, the separation type film was separated off from the adhesive layer and the hardness of the surface of the cured adhesive layer was measured in a manner similar to Examples 1 to 9. The results are listed in Table 3.

Table 3 indicates the results of measurement and evaluation performed in a manner similar to Examples 1 to 9 on the following items for the transparent electrically conductive laminated plates for a touch panel obtained in Examples 19 to 27 and Comparative Examples 13 to 16 and the transparent electrically conductive films for a touch panel obtained in Comparative Examples 17 and 18.

(2) Processing Suitability (Separation, Floating): Similar to Examples 1 to 9

(3) Adhesion

The polyester film having the hard coat layer in the transparent electrically conductive laminated plate for a touch panel and another member included in the laminated plate were separated from each other; thus, the adhesion therebetween was measured and evaluated in a manner similar to Examples 1 to 9.

(4) Stiffness: Similar to Examples 1 to 9

TABLE 3

| | Thickness | | | | |
|---|---|---|---|---|---|
| | of | | | | |
| | laminated | | | | |
| | plate | | | | |
| | (excluding | | Processing | | |
| | hard | Martens | suitability | | |
| | coat layer) | hardness | (separation, | Ad- | |
| | [μm] | [N/mm²] | floating) | hesion | Stiffness |
| Example 19 | 386 | 8 | Good | Good | Excellent |
| Example 20 | 386 | 20 | Good | Good | Excellent |
| Example 21 | 386 | 180 | Good | Good | Excellent |
| Example 22 | 386 | 258 | Good | Good | Excellent |
| Example 23 | 510 | 8 | Good | Good | Excellent |
| Example 24 | 210 | 8 | Good | Good | Good |
| Example 25 | 708 | 8 | Good | Good | Excellent |
| Example 26 | 770 | 8 | Good | Good | Excellent |
| Example 27 | 386 | 2 | Good | Good | Excellent |
| Comparative | 386 | 270 | Poor | Good | Excellent |
| Example 13 | | | | | |
| Comparative | 386 | 354 | Poor | Good | Excellent |
| Example 14 | | | | | |
| Comparative | 386 | 397 | Poor | Good | Excellent |
| Example 15 | | | | | |
| Comparative | 386 | 330 | Poor | Poor | Excellent |
| Example 16 | | | | | |
| Comparative | 250 | — | — | — | Good |
| Example 17 | | | | | |
| Comparative | 188 | — | — | — | Poor |
| Example 18 | | | | | |

As is clear from the above results, the transparent electrically conductive laminated plates for a touch panel of Examples 19 to 27 had a Martens hardness of 260 N/mm² or less; therefore, the floating or separation was able to be prevented during the die cutting processing. In particular, the transparent electrically conductive laminated plates for a touch panel of Examples 19 to 23 and Example 27 had a thickness of the plastic film+the adhesive layer in the range of 250 μm to 700 μm, which provided sufficient body.

The transparent electrically conductive laminated plate for a touch panel of Example 19 had an adhesion strength of the adhesive layer of 15 Newtons or more per 25 mm in width. Therefore, it was not able to separate the two plastic films off from each other after the die cutting processing, and they were particularly firmly adhered to each other.

The thickness of the plastic film+the adhesive layer of the transparent electrically conductive laminated plate for a touch panel of Example 24 is smaller than that of Example 19. Since the total thickness (210 μm) is relatively small, the transparent electrically conductive laminated plate for a touch panel of Example 24 was slightly bent by the touch by a finger; however, the stiffness was as high as that of one plastic film with larger thickness than that (Comparative Example 17: 250 μm). This has indicated that the transparent electrically conductive laminated plate of Example 24 has stronger stiffness than one plastic film with substantially the same thickness.

The transparent electrically conductive laminated plates for a touch panel of Examples 25 and 26 have larger thickness of the plastic film+the adhesive layer than that of Example 19. The larger thickness led to extremely sufficient stiffness. Note that, however, the large total thickness required a large force for die cutting processing as compared with the transparent electrically conductive laminated plates for a touch panel of Examples 19 to 24.

On the other hand, the transparent electrically conductive laminated plates for a touch panel of Comparative Examples 13 to 15 had the separation or floating in the die cutting processing because of having a Martens hardness of more than 260 N/mm²

The intermediate layer provided instead of the adhesive layer in the transparent electrically conductive laminated plate for a touch panel of Comparative Example 16 had a Martens hardness of more than 260 N/mm² and the adhesion strength between the two plastic films was less than 10 Newtons per 25 mm in width; therefore, the adhesion between the plastic film and the adhesive layer was so low that the plastic film was easily separated off. As a result, the repelling of the plastic film was not able to be suppressed in the due cutting processing so that the separation or floating occurred.

The functional films of Comparative Examples 17 and 18 have the heat ray reflection layer and the hard coat layer provided on one plastic film. Not having two or more plastic films and having small thickness of the plastic film, the functional films thereof did not have sufficient stiffness.

### 4. Fabrication of Touch Panel

The transparent electrically conductive laminated plates for a touch panel of Examples 19 to 26 and Comparative Examples 13 to 16 and the transparent electrically conductive films for a touch panel of Comparative Examples 17 and 18 were each incorporated as an upper electrode of a commercially available resistive touch panel, so that a resistive touch panel was fabricated. The touch panel obtained had stiffness and tactile sensation (touch sensitivity) in spite of light weight and had no risk of glass scattering during handling.

### DESCRIPTION OF REFERENCE SIGNS

1 . . . Functional laminated plate
2 . . . Transparent electrically conductive layer
3 . . . Insulation layer
4 . . . Protection layer
5 . . . Electromagnetic wave shielding layer
6 . . . Transparent electrically conductive laminated plate for touch panel
7 . . . Leading electrode line
8 . . . Spacer
9 . . . Hard coat layer
10 . . . Transparent laminated plate
11 . . . Plastic film
12 . . . Adhesive layer
13 . . . Functional layer
20 . . . Touch panel

1. A functional laminated plate comprising at least two plastic films adhered to each other through an adhesive layer, at least one of the plastic films having a functional layer provided on one surface or both surfaces of the plastic film,
characterized in that the adhesive layer has a Martens hardness of 260 N/mm² or less.

2. A functional laminated plate comprising at least two plastic films adhered to each other through an adhesive layer,
characterized in that at least one functional layer is provided between the plastic films, and the adhesive layer has a Martens hardness of 260 N/mm² or less.

3. The functional laminated plate according to claim 2,
characterized in that the functional layer has a function selected from an electromagnetic wave shielding function, a heat ray reflection function, a gas barrier function, and a planar heat generation function.

4. A functional laminated plate comprising at least two plastic films adhered to each other through an adhesive layer,
characterized in that a functional layer is provided for at least one surface of the plastic films on an outermost surface and the adhesive layer has a Martens hardness of 260 N/mm² or less.

5. The functional laminated plate according to claim 4,
characterized in that the functional layer has a function selected from a light reflection function, a light transmission control function, and an antifogging function.

6. The functional laminated plate according to claim 1,
characterized in that the plastic films and the adhesive layer have a total thickness of 200 to 700 μm, and each of the plastic films has a thickness of 50 to 400 μm.

7. The functional laminated plate according to claim 1,
characterized in that a resin included in the adhesive layer contains a thermosetting resin or an ionizing radiation curable resin.

8. The functional laminated plate according to claim 1,
characterized in that the adhesive layer also serves as the functional layer.

9. A transparent electrically conductive laminated plate for a touch panel, characterized by comprising a transparent laminated plate,
wherein the transparent laminated plate includes at least two transparent plastic films adhered to each other through an adhesive layer having a Martens hardness of 260 N/mm² or less, and
wherein a transparent electrically conductive layer is provided for at least one surface of the transparent laminated plate.

10. The transparent electrically conductive laminated plate for a touch panel according to claim 9,
characterized in that the transparent plastic films and the adhesive layer have a total thickness of 200 to 700 μm and each of the plastic films has a thickness of 50 to 400 μm.

11. The transparent electrically conductive laminated plate for a touch panel according to claim 9,
characterized in that a resin included in the adhesive layer contains a thermosetting resin or an ionizing radiation curable resin.

12. An electrostatic capacitive touch panel comprising a transparent electrically conductive base including a transparent electrically conductive layer on at least one surface of a transparent base,
characterized in that the transparent base is a transparent laminated plate including at least two transparent plastic films adhered to each other through an adhesive layer having a Martens hardness of 260 N/mm² or less.

13. A resistive touch panel comprising:
an upper electrode including a transparent electrically conductive layer on a transparent base; and
a lower electrode including a transparent electrically conductive layer on a transparent base,
wherein the upper electrode and the lower electrode are arranged through spacers so that the transparent electrically conductive layers face each other,
characterized in that the transparent base of the upper electrode and/or the transparent base of the lower electrode is a transparent laminated plate including at least two plastic films adhered to each other through an adhesive layer having a Martens hardness of 260 N/mm² or less.

14. The functional laminated plate according to claim 2,
characterized in that the plastic films and the adhesive layer have a total thickness of 200 to 700 μm, and each of the plastic films has a thickness of 50 to 400 μm.

15. The functional laminated plate according to claim 4,
characterized in that the plastic films and the adhesive layer have a total thickness of 200 to 700 μm, and each of the plastic films has a thickness of 50 to 400 μm.

16. The functional laminated plate according to claim 2,
characterized in that a resin included in the adhesive layer contains a thermosetting resin or an ionizing radiation curable resin.

17. The functional laminated plate according to claim 4,
characterized in that a resin included in the adhesive layer contains a thermosetting resin or an ionizing radiation curable resin.

18. The functional laminated plate according to claim 2,
characterized in that the adhesive layer also serves as the functional layer.

19. The transparent electrically conductive laminated plate for a touch panel according to claim 10,
characterized in that a resin included in the adhesive layer contains a thermosetting resin or an ionizing radiation curable resin.
